(19) United States
(12) Patent Application Publication
(10) Pub. No.: US 2022/0303995 A1
(43) Pub. Date: Sep. 22, 2022

(54) FREQUENCY MULTIPLEXING FOR CONTROL INFORMATION OVER SHARED CHANNEL RESOURCES

(71) Applicant: QUALCOMM Incorporated, San Diego, CA (US)

(72) Inventors: Hemant Saggar, Irvine, CA (US); Iyab Issam Sakhnini, San Diego, CA (US); Tao Luo, San Diego, CA (US)

(21) Appl. No.: 17/206,465

(22) Filed: Mar. 19, 2021

(51) Int. Cl. H04W 72/04; H04W 24/08; H04W 72/12

(52) U.S. Cl. CPC H04W 72/0493; H04W 72/042; H04W 72/0453; H04W 24/08; H04W 72/1263

(57) ABSTRACT

Methods, systems, and devices for wireless communications are described. A user equipment (UE) may receive a control message indicating frequency multiplexing for downlink control information (DCI) over a set of downlink shared channel resources of a downlink shared channel occasion. The UE may determine a frequency multiplexing configuration (e.g., mapping locations) for the DCI. The UE may monitor the downlink shared channel occasion for the set of downlink shared channel resources based on the frequency multiplexing configuration. In some cases, the UE may receive one or more downlink reference signals for the DCI over the set of downlink shared channel resources. For example, the UE may receive downlink reference signals dedicated for the DCI, downlink reference signals dedicated for the set of downlink shared channel resources, or both.

### FIELD OF TECHNOLOGY

The following relates to wireless communications, including frequency multiplexing for control information over shared channel resources.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a base station may transmit downlink control information (DCI) to a user equipment (UE) via a downlink control channel (e.g., a physical downlink control channel (PDCCH)). The DCI may include uplink scheduling grants, which may include resources and transport formats for the UE to use for uplink transmissions (e.g., transmitted via an uplink shared channel, such as a physical uplink shared channel (PUSCH)). However, to receive DCI, the UE may blindly decode PDCCH transmissions. That is, the UE may decode a set of PDCCH candidates to determine whether DCI has been transmitted to the UE. Blind decoding may increase power consumption, which increases as the number of PDCCH candidates for a UE increases.

### SUMMARY

The described techniques relate to improved methods, systems, devices, and apparatuses that support frequency multiplexing for control information over shared channel resources. Generally, the described techniques provide for frequency multiplexing for downlink control information (DCI) over a downlink shared channel (e.g., a physical downlink shared channel (PDSCH)). A user equipment (UE) may receive (e.g., from a base station) a control message that indicates frequency multiplexing for DCI within a set of downlink shared channel resources (e.g., PDSCH resources, such as time resources or frequency resources) of a downlink shared channel occasion (e.g., a PDSCH occasion). For instance, a base station may allocate resources (e.g., of the set of PDSCH resources) for DCI in a PDSCH occasion, and may interleave (e.g., in the frequency domain) the DCI resources with the PDSCH resources for transmission. The UE may determine a frequency multiplexing configuration, a frequency multiplexing mapping for the DCI (e.g., mapping locations for the DCI, where the mapping may be applied for one or more PDSCH occasions), or both, and may monitor the set of PDSCH resources accordingly. In some cases, the UE may also monitor the PDSCH occasion for a downlink reference signal (e.g., a demodulation reference signal (DMRS)) and may perform channel estimation for the PDSCH occasion based on the downlink reference signal. For example, the UE may receive downlink reference signals corresponding to multiplexed DCI, where the downlink reference signals may be dedicated for the DCI, for the set of PDSCH resources within the PDSCH occasion, or both.

A method for wireless communications at a UE is described. The method may include receiving a control message that indicates frequency multiplexing for DCI within a set of downlink shared channel resources of a downlink shared channel occasion, determining a frequency multiplexing configuration for the DCI over the set of downlink shared channel resources based on the control message, and monitoring the downlink shared channel occasion for the DCI in accordance with the frequency multiplexing configuration.

An apparatus for wireless communications at a UE is described. The apparatus may include a processor, memory coupled with the processor, and instructions stored in the memory. The instructions may be executable by the processor to cause the apparatus to receive a control message that indicates frequency multiplexing for DCI within a set of downlink shared channel resources of a downlink shared channel occasion, determine a frequency multiplexing configuration for the DCI over the set of downlink shared channel resources based on the control message, and monitor the downlink shared channel occasion for the DCI in accordance with the frequency multiplexing configuration.

Another apparatus for wireless communications at a UE is described. The apparatus may include means for receiving a control message that indicates frequency multiplexing for DCI within a set of downlink shared channel resources of a downlink shared channel occasion, means for determining a frequency multiplexing configuration for the DCI over the set of downlink shared channel resources based on the control message, and means for monitoring the downlink shared channel occasion for the DCI in accordance with the frequency multiplexing configuration.

A non-transitory computer-readable medium storing code for wireless communications at a UE is described. The code may include instructions executable by a processor to receive a control message that indicates frequency multiplexing for DCI within a set of downlink shared channel resources of a downlink shared channel occasion, determine a frequency multiplexing configuration for the DCI over the set of downlink shared channel resources based on the control message, and monitor the downlink shared channel occasion for the DCI in accordance with the frequency multiplexing configuration.

Some examples of the method, apparatuses, and non-transitory computer-readable medium described herein may further include operations, features, means, or instructions for determining a frequency span for the DCI, the frequency span corresponding to a number of resource elements per symbol for multiplexing of the DCI within the set of downlink shared channel resources, where monitoring the downlink shared channel occasion for the DCI may be based on the number of resource elements per symbol.

Some examples of the method, apparatuses, and non-transitory computer-readable medium described herein may further include operations, features, means, or instructions for determining a number of portions of the DCI to be multiplexed in a first symbol of the set of downlink shared channel resources based on a number of resource elements per symbol, a number of available resource element locations in the set of downlink shared channel resources, a content of the downlink control to be multiplexed in the first symbol, or any combination thereof, where monitoring the downlink shared channel occasion for the DCI may be based on the number of portions of the DCI.

Some examples of the method, apparatuses, and non-transitory computer-readable medium described herein may further include operations, features, means, or instructions for determining mapping locations for the number of portions of the DCI to be multiplexed in the first symbol based on the number of portions and the frequency multiplexing configuration.

In some examples of the method, apparatuses, and non-transitory computer-readable medium described herein, determining the mapping locations may include operations, features, means, or instructions for determining a first mapping location for a first portion of the DCI based on a starting resource element index in the first symbol and determining a second mapping location for a second portion of the DCI based on an offset and the first mapping location.

In some examples of the method, apparatuses, and non-transitory computer-readable medium described herein, the frequency multiplexing configuration includes an indication of the first mapping location and the offset.

In some examples of the method, apparatuses, and non-transitory computer-readable medium described herein, the mapping locations correspond to resource elements indicated by the frequency multiplexing configuration.

In some examples of the method, apparatuses, and non-transitory computer-readable medium described herein, the mapping locations may be uniformly spread within a bandwidth of the first symbol.

Some examples of the method, apparatuses, and non-transitory computer-readable medium described herein may further include operations, features, means, or instructions for receiving a message that indicates allocation information for one or more portions of DCI, the allocation information including a type of information included in the one or more portions of DCI.

Some examples of the method, apparatuses, and non-transitory computer-readable medium described herein may further include operations, features, means, or instructions for receiving one or more reference signals associated with the DCI within the set of downlink shared channel resources and performing channel estimation for the DCI based on the one or more reference signals.

In some examples of the method, apparatuses, and non-transitory computer-readable medium described herein, at least one reference signal of the one or more reference signals may be located in a first set of frequency resources of the set of downlink shared channel resources that may be non-overlapping with a second set of resources of the set of downlink shared channel resources used for the DCI.

In some examples of the method, apparatuses, and non-transitory computer-readable medium described herein, at least one reference signal of the one or more reference signals may be located in a first set of frequency resources of the set of downlink shared channel resources that may be overlapping with a second set of resources of the set of downlink shared channel resources used for the DCI.

In some examples of the method, apparatuses, and non-transitory computer-readable medium described herein, the one or more reference signals may be located in an initial set of time resources of the set of downlink shared channel resources.

Some examples of the method, apparatuses, and non-transitory computer-readable medium described herein may further include operations, features, means, or instructions for receiving an indication that the one or more reference signals may be located in each symbol of the set of downlink shared channel resources.

Some examples of the method, apparatuses, and non-transitory computer-readable medium described herein may further include operations, features, means, or instructions for receiving, in a first symbol of the downlink shared channel resources, one or more reference signals for the set of downlink shared channel resources and performing channel estimation for the first symbol based on the one or more reference signals.

Some examples of the method, apparatuses, and non-transitory computer-readable medium described herein may further include operations, features, means, or instructions for performing channel estimation for a second symbol of the set of downlink shared channel resources based on the one or more reference signals.

Some examples of the method, apparatuses, and non-transitory computer-readable medium described herein may further include operations, features, means, or instructions for receiving, in the first symbol of the downlink shared channel resources, one or more second reference signals dedicated for the DCI and performing channel estimation for the DCI based on the one or more second reference signals.

Some examples of the method, apparatuses, and non-transitory computer-readable medium described herein may further include operations, features, means, or instructions for receiving one or more reference signals in one or more resource elements in at least one portion of the DCI, where the one or more reference signals may be dedicated for the DCI, the set of downlink shared channel resources, or both and performing channel estimation for the DCI based on the one or more reference signals.

In some examples of the method, apparatuses, and non-transitory computer-readable medium described herein, performing channel estimation may include operations, features, means, or instructions for interpolating between the at least one portion and at least one other portion in which the one or more reference signals may be received to obtain a set of interpolated reference signals, where the channel estimation may be performed based on the set of interpolated reference signals.

Some examples of the method, apparatuses, and non-transitory computer-readable medium described herein may further include operations, features, means, or instructions for receiving a first set of reference signals dedicated for the DCI on a first set of resource elements in one or more portions of the DCI and performing channel estimation for the first symbol based on the first set of reference signals.

Some examples of the method, apparatuses, and non-transitory computer-readable medium described herein may further include operations, features, means, or instructions for receiving a second set of reference signals dedicated for the DCI on a second set of resource elements of the set of downlink shared channel resources, where the channel estimation may be performed based on the first set of reference signals and the second set of reference signals.

In some examples of the method, apparatuses, and non-transitory computer-readable medium described herein, the first set of reference signals may be received according to a first reference signal density and a first uniform spacing and the second set of reference signals may be received according to a second reference signal density and a second uniform spacing.

In some examples of the method, apparatuses, and non-transitory computer-readable medium described herein, the first set of reference signals may be received according to a first set of precoding parameters and the second set of reference signals may be received according to a second set of precoding parameters.

Some examples of the method, apparatuses, and non-transitory computer-readable medium described herein may further include operations, features, means, or instructions for receiving a message that indicates frequency hopping may be activated for the DCI, determining an offset for a frequency multiplexing pattern for the frequency multiplexing configuration, and monitoring for the DCI based on the offset.

Some examples of the method, apparatuses, and non-transitory computer-readable medium described herein may further include operations, features, means, or instructions for receiving each portion of the DCI according to a respective set of precoding parameters, where each of the respective sets of precoding parameters may be different and receiving respective sets of reference signals for each portion of the DCI based on the respective sets of precoding parameters.

A method for wireless communications at a base station is described. The method may include transmitting, to a UE, a control message that indicates frequency multiplexing for DCI within a set of downlink shared channel resources of a downlink shared channel occasion for the UE, determining a frequency multiplexing configuration for the DCI over the set of downlink shared channel resources based on the control message, and transmitting the DCI over the set of downlink shared channel resources in accordance with the frequency multiplexing configuration.

An apparatus for wireless communications at a base station is described. The apparatus may include a processor, memory coupled with the processor, and instructions stored in the memory. The instructions may be executable by the processor to cause the apparatus to transmit, to a UE, a control message that indicates frequency multiplexing for DCI within a set of downlink shared channel resources of a downlink shared channel occasion for the UE, determine a frequency multiplexing configuration for the DCI over the set of downlink shared channel resources based on the control message, and transmit the DCI over the set of downlink shared channel resources in accordance with the frequency multiplexing configuration.

Another apparatus for wireless communications at a base station is described. The apparatus may include means for transmitting, to a UE, a control message that indicates frequency multiplexing for DCI within a set of downlink shared channel resources of a downlink shared channel occasion for the UE, means for determining a frequency multiplexing configuration for the DCI over the set of downlink shared channel resources based on the control message, and means for transmitting the DCI over the set of downlink shared channel resources in accordance with the frequency multiplexing configuration.

A non-transitory computer-readable medium storing code for wireless communications at a base station is described. The code may include instructions executable by a processor to transmit, to a UE, a control message that indicates frequency multiplexing for DCI within a set of downlink shared channel resources of a downlink shared channel occasion for the UE, determine a frequency multiplexing configuration for the DCI over the set of downlink shared channel resources based on the control message, and transmit the DCI over the set of downlink shared channel resources in accordance with the frequency multiplexing configuration.

Some examples of the method, apparatuses, and non-transitory computer-readable medium described herein may further include operations, features, means, or instructions for transmitting a message that indicates frequency hopping may be activated for the frequency for the DCI, determining an offset for a frequency multiplexing pattern for the frequency multiplexing configuration, and transmitting the DCI based on the offset.

Some examples of the method, apparatuses, and non-transitory computer-readable medium described herein may further include operations, features, means, or instructions for transmitting a message that indicates allocation information for one or more portions of DCI, the allocation information including a type of information included in the one or more portions of DCI.

Some examples of the method, apparatuses, and non-transitory computer-readable medium described herein may further include operations, features, means, or instructions for transmitting one or more reference signals associated with the DCI within the set of downlink shared channel resources.

In some examples of the method, apparatuses, and non-transitory computer-readable medium described herein, at least one reference signal of the one or more reference signals may be located in a first set of frequency resources of the set of downlink shared channel resources that may be non-overlapping with a second set of resources of the set of downlink shared channel resources used for the DCI.

In some examples of the method, apparatuses, and non-transitory computer-readable medium described herein, at least one reference signal of the one or more reference signals may be located in a first set of frequency resources of the set of downlink shared channel resources that may be overlapping with a second set of resources of the set of downlink shared channel resources used for the DCI.

In some examples of the method, apparatuses, and non-transitory computer-readable medium described herein, the one or more reference signals may be located in an initial set of time resources of the set of downlink shared channel resources.

Some examples of the method, apparatuses, and non-transitory computer-readable medium described herein may further include operations, features, means, or instructions for transmitting an indication that the one or more reference signals may be located in each symbol of the set of downlink shared channel resources.

Some examples of the method, apparatuses, and non-transitory computer-readable medium described herein may further include operations, features, means, or instructions for transmitting, in a first symbol of the downlink shared channel resources, one or more reference signals for the set of downlink shared channel resources.

Some examples of the method, apparatuses, and non-transitory computer-readable medium described herein may further include operations, features, means, or instructions for transmitting, in the first symbol of the downlink shared channel resources, one or more second reference signals dedicated for the DCI.

Some examples of the method, apparatuses, and non-transitory computer-readable medium described herein may further include operations, features, means, or instructions for transmitting one or more reference signals in one or more resource elements in each portion of the DCI, where the one or more reference signals may be dedicated for the DCI, the set of downlink shared channel resources, or both.

Some examples of the method, apparatuses, and non-transitory computer-readable medium described herein may further include operations, features, means, or instructions for transmitting a first set of reference signals dedicated for the DCI on a first set of resource elements in one or more portions of the DCI and transmitting a second set of reference signals dedicated for the DCI on a second set of resource elements of the set of downlink shared channel resources.

In some examples of the method, apparatuses, and non-transitory computer-readable medium described herein, the first set of reference signals may be transmitted according to a first reference signal density and a first uniform spacing and the second set of reference signals may be transmitted according to a second reference signal density and a second uniform spacing.

In some examples of the method, apparatuses, and non-transitory computer-readable medium described herein, the first set of reference signals may be transmitted according to a first set of precoding parameters and the second set of reference signals may be transmitted according to a second set of precoding parameters.

Some examples of the method, apparatuses, and non-transitory computer-readable medium described herein may further include operations, features, means, or instructions for transmitting each portion of the DCI according to a respective set of precoding parameters, where each of the respective sets of precoding parameters may be different and transmitting respective sets of reference signals for each portion of the DCI based on the respective sets of precoding parameters.

### BRIEF DESCRIPTION OF THE DRAWINGS

FIG. 1 illustrates an example of a wireless communications system that supports frequency multiplexing for control information over shared channel resources in accordance with aspects of the present disclosure.

FIG. 2 illustrates an example of a wireless communications system that supports frequency multiplexing for control information over shared channel resources in accordance with aspects of the present disclosure.

FIG. 3 illustrates an example of a frequency multiplexing configuration that supports frequency multiplexing for control information over shared channel resources in accordance with aspects of the present disclosure.

FIGS. 4A and 4B illustrate examples of resource allocation configurations that support frequency multiplexing for control information over shared channel resources in accordance with aspects of the present disclosure.

FIG. 5 illustrates an example of a process flow that supports frequency multiplexing for control information over shared channel resources in accordance with aspects of the present disclosure.

FIGS. 6 and 7 show block diagrams of devices that support frequency multiplexing for control information over shared channel resources in accordance with aspects of the present disclosure.

FIG. 8 shows a block diagram of a communications manager that supports frequency multiplexing for control information over shared channel resources in accordance with aspects of the present disclosure.

FIG. 9 shows a diagram of a system including a device that supports frequency multiplexing for control information over shared channel resources in accordance with aspects of the present disclosure.

FIGS. 10 and 11 show block diagrams of devices that support frequency multiplexing for control information over shared channel resources in accordance with aspects of the present disclosure.

FIG. 12 shows a block diagram of a communications manager that supports frequency multiplexing for control information over shared channel resources in accordance with aspects of the present disclosure.

FIG. 13 shows a diagram of a system including a device that supports frequency multiplexing for control information over shared channel resources in accordance with aspects of the present disclosure.

FIGS. 14 through 17 show flowcharts illustrating methods that support frequency multiplexing for control information over shared channel resources in accordance with aspects of the present disclosure.

### DETAILED DESCRIPTION

In some wireless communications systems, a base station may transmit control information (e.g., downlink control information (DCI)) to a user equipment (UE) over a downlink control channel, such as a physical downlink control channel (PDCCH). The UE may blindly decode the PDCCH to receive the DCI, which may increase power consumption at the UE. Further, in some cases, DCI transmitted over PDCCH may experience fading or interference, which may result in signal loss. A base station may improve communications reliability and efficiency by transmitting DCI over a set of symbols of a downlink shared control channel occasion (e.g., a physical downlink shared channel (PDSCH) occasion). For example, the base station may leverage higher beamforming gain associated with PDSCH transmissions to overcome signal loss. Additionally, transmitting DCI over PDSCH may result in decreased overhead and reduced blind decoding processes (e.g., thereby reducing UE power consumption), as the UE may receive an indication of the location of the DCI in a PDSCH transmission. In some cases, the base station may configure a set of semi-persistent scheduling (SPS) occasions for PDSCH transmissions. In such cases, the UE may receive DCI periodically (e.g., as part of SPS transmissions), which may reduce the number of blind decoding procedures performed by the UE. In some examples, transmitting DCI over PDSCH may also reduce signaling overhead, which may be useful for reduced capability (Redcap) devices (e.g., surveillance cameras, industrial wireless sensors, smart watches, medical wearables, etc.).

According to the techniques described herein, the base station may increase communications reliability through frequency diversity by multiplexing control information (e.g., DCI) with a set of downlink shared channel resources (e.g., PDSCH resources) of a downlink shared channel occasion (e.g., a PDSCH) occasion). For example, the base station may transmit (e.g., to a UE) DCI in one or more PDSCH occasions according to a frequency multiplexing configuration, where the DCI may be split into a number of portions and multiplexed across one or more symbols of the set of PDSCH resources. The base station may transmit, to the UE, a control message (e.g., DCI, a media access control element (MAC-CE), radio resource control (RRC) signaling, or the like) that includes an indication of the frequency multiplexing for the DCI. The UE may determine a frequency multiplexing configuration for the DCI over the PDSCH resources and may monitor the PDSCH occasion accordingly.

The UE may also receive (e.g., from the base station) one or more downlink reference signals (e.g., demodulation reference signals (DMRS)) associated with the DCI within the set of PDSCH resources. Based on the one or more downlink reference signals, the UE may perform channel estimation for the DCI, the PDSCH occasion, or some combination thereof. In some cases, the one or more downlink reference signals may be dedicated for the DCI, dedicated for the PDSCH resources, shared between both the DCI and the PDSCH resources, or some combination thereof. In some examples, the UE may receive the one or more downlink reference signals in a portion of the DCI, in the set of PDSCH resources, or both. For example, the UE may receive dedicated downlink reference signals in one or more multiplexed DCI resource elements, shared downlink reference signals within the set of PDSCH resources, or both. The UE may utilize the downlink reference signals to perform channel estimation, e.g., based on the location of the downlink reference signals.

Aspects of the disclosure are initially described in the context of wireless communications systems. Aspects of the disclosure are then described with references to multiplexing processes, multiplexing arrangements, and process flows. Aspects of the disclosure are further illustrated by and described with reference to apparatus diagrams, system diagrams, and flowcharts that relate to frequency multiplexing for control information over shared channel resources.

Aspects of the disclosure are initially described in the context of wireless communications systems. Aspects of the disclosure are then described with reference to a frequency multiplexing configuration, a resource allocation configuration, and a process flow. Aspects of the disclosure are further illustrated by and described with reference to apparatus diagrams, system diagrams, and flowcharts that relate to frequency multiplexing for control information over shared channel resources.

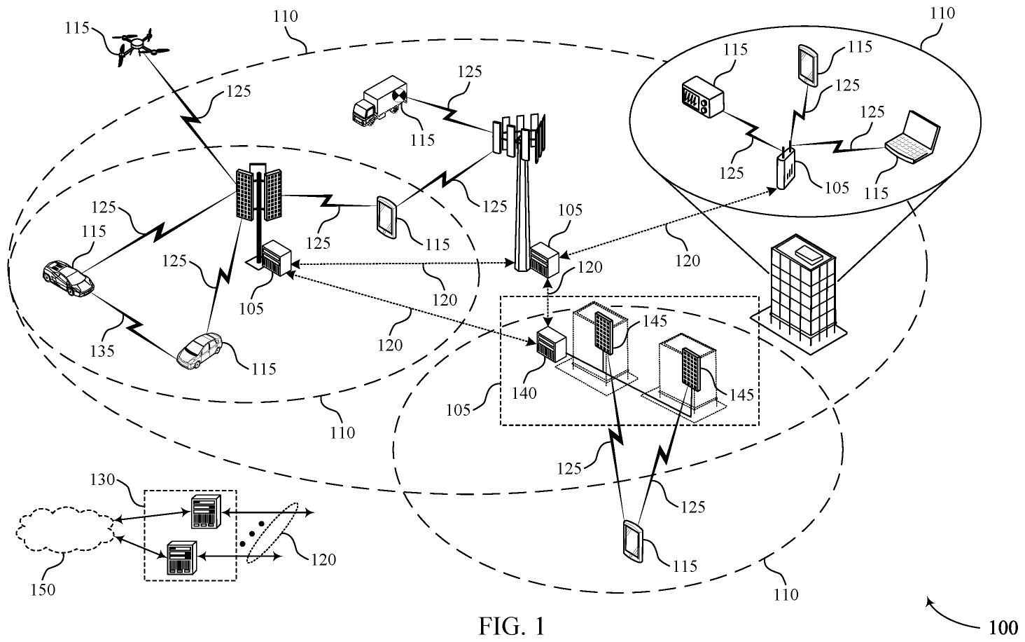

FIG. 1 illustrates an example of a wireless communications system 100 that supports frequency multiplexing for control information over shared channel resources in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A base station 105 may communicate with a UE 115 over a downlink control channel (e.g., a PDCCH). For example, the base station 105 may transmit DCI during PDCCH occasions. The UE 115 may blindly decode PDCCH candidates while monitoring the PDCCH occasion, for instance, according to a configured search space. In some examples, the base station 105 may instead transmit DCI over a downlink shared channel (e.g., PDSCH) during a downlink shared channel occasion. In such examples, the base station 105 may allocate resources (e.g., time resources, frequency resources) within the PDSCH occasion for the DCI. The base station 105 may indicate, to the UE 115, the location (e.g., the resources) or the contents of the DCI. For instance, the base station 105 may include an indication in DCI transmitted over a control channel (e.g., PDCCH) prior to the DCI that is to be transmitted over the PDSCH. In some examples, the base station 105 may instead include the indication as part of RRC signaling, a MAC-CE, or other control messages.

The techniques described herein support a base station 105 and a UE 115 utilizing frequency multiplexing for DCI over a downlink shared channel (e.g., a PDSCH). The base station 105 may transmit, and the UE 115 may receive, an indication (e.g., as part of a control message) of frequency multiplexing for DCI within a set of downlink shared channel resources (e.g., PDSCH resources) of a downlink shared channel occasion (e.g., PDSCH occasion). For instance, DCI may be multiplexed and transmitted on the set of PDSCH resources of the PDSCH occasion. The UE 115 may determine a frequency multiplexing configuration (e.g., a frequency multiplexing mapping for the DCI on the set of PDSCH resources) based on the control message. For example, the UE 115 may determine a number of portions of the DCI to be multiplexed in one or more symbols of the set of PDSCH resources. The number of portions may be based on a number of resource elements (REs) per symbol, where one RE may span or include multiple subcarriers. Additionally, or alternatively, the number of portions may be based on a number of available REs in the set of PDSCH resources, content(s) of the DCI to be multiplexed in the one or more symbols, or some combination thereof. In some cases, the UE 115 may determine mapping locations for each portion of the number of portions based on the frequency multiplexing configuration, where the mapping locations may correspond to resource elements of the set of PDSCH resources.

The base station 105 may transmit the DCI to the UE 115 during the PDSCH occasion. The UE 115 may monitor, during the PDSCH occasion, the set of PDSCH resources according to the frequency multiplexing configuration. In some cases, the UE 115 may also monitor the set of PDSCH resources for one or more downlink reference signals transmitted by the base station 105. For instance, the base station 105 may transmit one or more downlink reference signals in a symbol of the PDSCH resources, in a portion of the DCI, or some combination thereof. The UE 115 may receive the one or more reference signals and may perform channel estimation for the DCI, the one or more symbols, or both based on the one or more downlink reference signals.

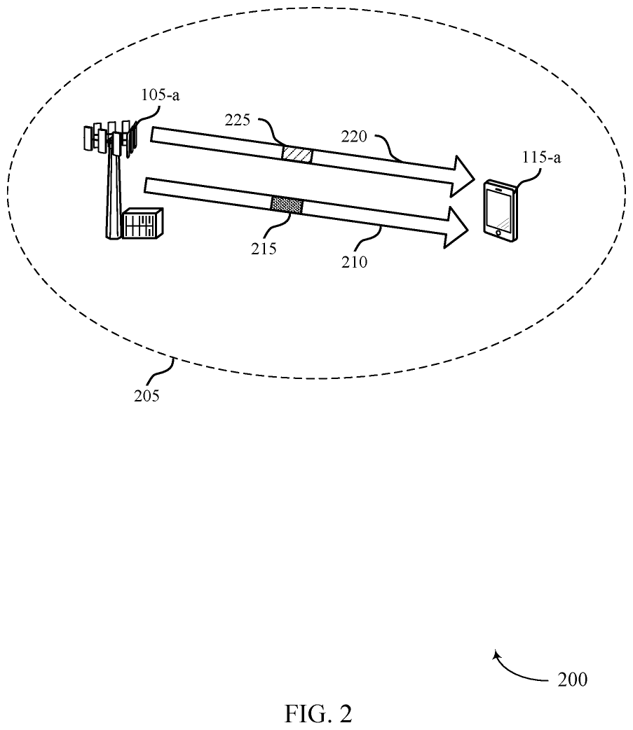

FIG. 2 illustrates an example of a wireless communications system 200 that supports frequency multiplexing for control information over shared channel resources in accordance with aspects of the present disclosure. The wireless communications system 200 may include a base station 105-a and UE 115-a, which may be examples of a base station 105 and a UE 115 as described with reference to FIG. 1. The base station 105-a may serve a geographic coverage area 205. The base station 105-a may communicate with the UE 115-a over a communication link 210 and a communication link 220. For instance, the communication link 210 may be an example of a downlink control channel (e.g., a PDCCH) and the communication link 220 may be an example of a downlink shared channel (e.g., a PDSCH).

The base station 105-a may transmit DCI to UE 115-a via PDCCH (e.g., via the communication link 210), for example, to indicate scheduling information or other control information. Coded and modulated DCI bits may be mapped onto a structure based on control channel elements (CCEs) and resource element groups (REGs), where one REG may correspond to 12 subcarriers in frequency and one OFDM symbol in time. One CCE may correspond to 6 REGs. The base station 105-a may include, as part of the DCI, downlink scheduling assignments for the UE 115-a. The downlink scheduling assignments may include information to enable the UE 115-a to properly receive, demodulate, and decode downlink messages on a shared channel (e.g., a PDSCH, such as communication link 220). Additionally or alternatively, the DCI may include uplink scheduling grants, which may include resources and transport formats for the UE 115-a to use for uplink transmissions (e.g., over an uplink shared channel, such as a physical uplink shared channel (PUSCH)). In any case, the base station 105-a may transmit DCI to the UE 115-a according to a DCI format (e.g., Formats 1_1, 1_0, 0_0, 0_1, 2_0, 2_1, 2_2, 2_3, etc.).

To receive the DCI, the UE 115-a may blindly decode PDCCH candidates based on configured search spaces. In some cases, the base station 105-a may improve communications by instead transmitting DCI to the UE 115-a over PDSCH (e.g., communication link 220). For example, a PDSCH may be associated with higher beamforming gains. Additionally, transmitting DCI over PDSCH may result in significant savings in blind decoding since locations of the DCI may be indicated to the UE 115-a (e.g., by the base station 105-a).

The base station 105-a and the UE 115-a may reduce or mitigate effects of signal loss (e.g., deep fading, interference, etc.) by changing frequencies used for communications. For example, the base station 105-a may use frequency multiplexing when transmitting messages to the UE 115-a, which may improve communications performance. As an example, the base station 105-a may assign frequencies for transmissions according to channel conditions; for instance, the base station 105-a may use frequency multiplexing to transmit a relatively more important message on a frequency that has relatively less interference. Frequency multiplexing may improve communications reliability, as increasing frequency diversity may increase the likelihood that messages are successfully received. For instance, a first frequency may experience fading, interference, or other degradation, such that a message transmitted to the UE 115-a via the first frequency may be received incorrectly or not received at all. However, if the message is also sent via a second frequency that does not experience such loss, the UE 115-a may have a greater chance at receiving at least one of the messages.

For example, the UE 115-a may transmit (e.g., via a physical uplink shared channel (PUSCH)) uplink control information (UCI) to the base station 105-a using multiplexing. For instance, the UE 115-a may multiplex the UCI over PUSCH resources by reserving REs for HARQ bits. The UE 115-a may map the UCI to PUSCH resources based on a number of REs available for the UCI transmission and the remaining REs required, e.g., for the UCI type associated with the UCI. However, techniques for multiplexing UCI over PUSCH resources, such as mapping techniques, may be limited. For example, the UCI may be uniformly distributed across available REs in a symbol only if the number of remaining REs required for the UCI type is less than or equal to half of the available REs for the UCI transmission. In some cases, such constraints may reduce communications performance. As a first example, only a subset of UCI bits may benefit from multiplexing (i.e., UE 115-a may not be capable of controlling the number of UCI bits being multiplexed in the PUSCH). Second, cross-resource block (RB) multiplexing may not be supported, nor may there be support for configuring dedicated downlink reference signals for the UCI to perform channel estimation. Third, other bits within the UCI may be punctured to accommodate HARQ bits. In other words, the UCI symbols may not be flexibly split and multiplexed into the PUSCH at desired locations.

The UE 115-a and the base station 105-a may, according to the techniques described herein, enable frequency multiplexing of control information over shared channel resources. For example, the base station 105-a may transmit DCI 225 over a PDSCH (e.g., communication link 220) on a set of PDSCH resources according to a frequency multiplexing configuration, which may be relatively more flexible, e.g., than techniques used for multiplexing UCI. The base station 105-a may split the DCI 225 into a number of portions and may multiplex the portions over the PDSCH resources at desired locations. In some examples, the multiplexed locations for each portion of the DCI 225 may vary across the set of PDSCH resources.

The base station 105-a may transmit (e.g., via a PDCCH, such as communication link 210), to the UE 115-a, a control message 215 that indicates frequency multiplexing of DCI 225 within a set of downlink shared channel resources (e.g., PDSCH resources) of a downlink shared channel occasion (e.g., a PDSCH occasion). The control message 215 may be an example of DCI, an RRC message, a MAC-CE, a previous DCI, or some combination thereof. The base station 105-a may determine a frequency multiplexing configuration and may allocate resources (e.g., time resources, frequency resources) of the set of PDSCH resources for the DCI. The base station 105-a may transmit the DCI 225 (e.g., using a same analog beam) according to the frequency multiplexing configuration.

Based on the control message 215, the UE 115-a may determine a frequency multiplexing configuration for the DCI 225. For example, the UE 115-a may determine a frequency span for the DCI 225, e.g., corresponding to a number of REs per symbol for multiplexing of the DCI 225. In some cases, the UE 115-a may determine a number of portions of the DCI 225 to be multiplexed in one or more symbols of the set of PDSCH resources, where the number of portions may be based on a number of REs per symbol or a number of available RE locations in the set of PDSCH resources, among other examples. In some examples, the UE 115-a may determine allocation information for the one or more portions of the DCI 225. For instance, the base station 105-a may determine that channel conditions for a first frequency are relatively better than other frequencies, and may determine to allocate a type of information to a portion of the DCI 225 that is to be multiplexed on the first frequency. The base station 105-a may transmit a message to the UE 115-a that indicates allocation information for the type of information to be included in the associated portions. Additionally or alternatively, the UE 115-a may determine mapping locations for each portion of the DCI 225 to be multiplexed in one or more symbols of the set of PDSCH resources.

As an example, the UE 115-a may determine a number of REs per symbol of the DCI 225 and a number of portions of the DCI 225 to be multiplexed. The size of each portion may be inversely proportional to the number of portions. The UE 115-a may determine a mapping for each portion to a frequency location in one or more symbols of the set of PDSCH resources. For instance, the UE 115-a may determine a starting RE (e.g., a starting RE index) in the first symbol for a first portion of the DCI 225. The UE 115-a may determine an RE (e.g., an RE index) for a second portion of the DCI 225 based on the starting RE and an offset, such as a number of REs. Alternatively, the UE 115-a may determine the mapping for each portion based on a uniform spread of the portions within a bandwidth of the PDSCH occasion.

The UE 115-a may monitor the PDSCH occasion for the DCI 225 in accordance with the frequency multiplexing configuration. In some examples, the base station 105-a may indicate frequency multiplexing parameters to the UE 115-a, e.g., before the PDSCH occasion, such that the UE 115-a may monitor the PDSCH occasion according to the parameters.

In some examples, the base station 105-a may transmit one or more downlink reference signals (e.g., DMRSs) associated with the DCI and in the set of PDSCH resources. Transmission of the downlink reference signals may be based on the frequency multiplexing configuration such that the UE 115-a may account for the varying frequencies associated with the frequency multiplexing configuration when performing channel estimation of the DCI 225, the set of PDSCH resources of the PDSCH occasion, or both. For example, the UE 115-a may receive downlink reference signals that are dedicated for the DCI 225 and may perform channel estimation for the DCI 225 based on the downlink reference signals. The dedicated downlink reference signals may be received in one or more resource elements of the DCI 225 (e.g., in one or more of the portions of the DCI 225), in one or more resources (e.g., symbols and frequency locations) of the set of PDSCH resources, or both. In some examples, the UE 115-a may receive (e.g., in the DCI 225, the set of PDSCH resources, or both) downlink reference signals to be used for channel estimation for both the DCI 225 and the set of PDSCH resources, which may also be referred to as shared downlink reference signals. The UE 115-a may perform channel estimation for the DCI 225, the set of PDSCH resources, or both, based on the downlink reference signals.

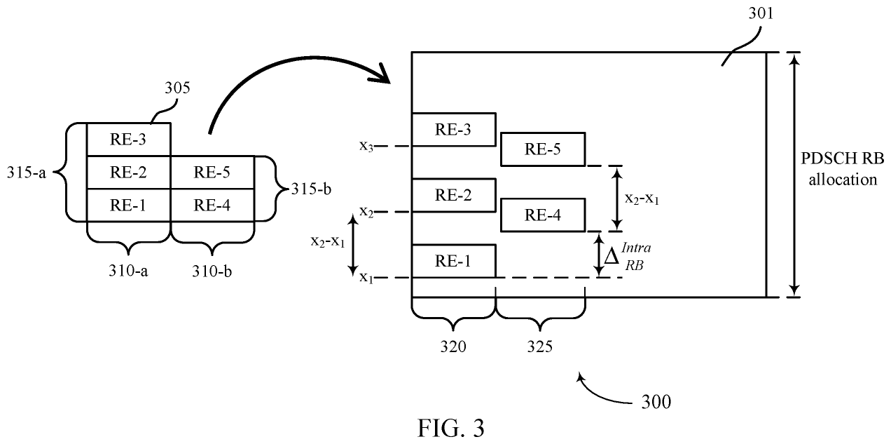

FIG. 3 illustrates an example of a frequency multiplexing configuration 300 that supports frequency multiplexing for control information over shared channel resources in accordance with aspects of the present disclosure. In some examples, the frequency multiplexing configuration 300 may implement aspects of the wireless communications systems 100 or 200. For example, the frequency multiplexing configuration 300 may be implemented by a UE 115 and a base station 105 as described with reference to FIGS. 1 and 2. In some cases, the frequency multiplexing configuration 300 may be a frequency multiplexing configuration as described with reference to FIG. 2.

As described herein, a base station may transmit, to a UE, a control message including an indication of frequency multiplexing for DCI 305 in a downlink shared channel occasion, such as a PDSCH occasion 301. The base station may transmit, and the UE may receive, DCI 305 that is multiplexed in the frequency domain within a set of downlink shared channel resources (e.g., PDSCH resources) of the PDSCH occasion 301 according to the frequency multiplexing configuration 300. The UE may determine the frequency multiplexing configuration 300 for the DCI 305 and may monitor the set of symbols for the DCI 305 according to the frequency multiplexing configuration 300.

The UE may determine that the DCI 305 has a frequency span of L REs per symbol, where an RE may be an example of a frequency resource and may correspond to one or more subcarriers. For example, the DCI 305 may include five REs across two symbols: a first symbol 310-a and a second symbol 310-b. The first symbol 310-a may include a resource block allocation 315-a. The resource block allocation 315-a may include three of the REs in one symbol (e.g., RE-1, RE-2, and RE-3) such that the first symbol 310-a has a frequency span of three (L=3). The symbol 310-b may include a resource block allocation 315-b that includes two REs (e.g., RE-4 and RE-5) such that the second symbol 310-b has a frequency span of two (L=2).

The UE may determine a number of portions of the DCI 305 to be multiplexed in one or more symbols of the set of PDSCH resources of the PDSCH occasion 301. The portions may be, for example, one or more REs. The UE may split the DCI 305 into N≤Nₘₐₓ portions (e.g., REs) per symbol, where N is a number of frequency locations over which contents of the DCI 305 are to be spread and Nₘₐₓ is a maximum number of frequency resources (e.g., REs) in a symbol. The value of N may be determined per symbol, based on, for example, the number of available RE locations within the set of PDSCH resources, the contents of the DCI 305, or both. The size of each portion may be inversely proportional to N. The UE may determine a number of the portions of the DCI 305 to be multiplexed in a symbol of the set of PDSCH resources based on the value of N (e.g., the number of REs per symbol), a number of available RE locations in the set of PDSCH resources, the content of the DCI 305, or any combination thereof. For example, the number of portions of the DCI 305 to be multiplexed in a first PDSCH symbol 320 may be different than the number of portions of the DCI 305 to be multiplexed in a second PDSCH symbol 325.

The UE may determine the frequency multiplexing configuration 300 by determining mapping locations of the portions of the DCI to one or more frequency locations of the set of PDSCH resources. For example, the first symbol 310-a of the DCI 305 may include three REs such that the resource allocation block 315-a is split into N=3 DCI portions. The REs of the first symbol 310-a may therefore be mapped to N=3 frequency locations inside the first PDSCH symbol 320. For example, the three REs of the first symbol 310-a may be multiplexed across three frequencies within the first PDSCH symbol 320: x₁, x₂, and x₃. The second symbol 310-b of the DCI 305 may include two REs such that the resource allocation block 315-b is split into N=2 DCI portions. The REs of the second symbol 310-b may be mapped to N=2 frequency locations inside the second PDSCH symbol 325, for instance, based on the mapping of the REs of the first symbol 310-a. For example, the two REs of the second symbol 310-b may be multiplexed across two frequencies within the second PDSCH symbol 325: x₂, and x₃.

In some cases, the UE may determine mapping locations for the REs based on a starting RE (e.g., a starting RE index) and an offset. For instance, the UE may determine mapping locations for the REs of the first symbol 310-a based on a starting RE index of the first PDSCH symbol 320. The UE may determine mapping locations for the REs of the second symbol 310-b based on the starting RE index and an offset. For instance, the offset may be a constant offset such that subsequent REs are received at frequency locations in increments of x₁-x₂. As illustrated in FIG. 3, in the first PDSCH symbol 320, RE-2 may be offset with respect to RE-1 in the frequency domain by x₁-x₂, and RE-5 may be offset with respect to RE-4 in the frequency domain by x₁-x₂.

In some examples, the base station may transmit, and the UE may receive, an indication that frequency hopping is activated for the DCI 305, and the UE may determine an offset for the frequency multiplexing configuration 300 based on the frequency hopping being activated. That is, the portions of the DCI 305 may be frequency hopped within the PDSCH occasion 301 such that the locations of the portions of the DCI 305 in each PDSCH symbol may be offset by an amount indicated by the frequency hopping. In the example of FIG. 3, the second symbol 310-b may be mapped to N frequency locations based on an offset (e.g., Δ_{RB}^{intra}) associated with frequency hopping of the DCI. As illustrated in FIG. 3, RE-4 may be offset, with respect to RE-1, in the frequency domain by Δ_{RB}^{intra}.

In some cases, the mapped locations within the PDSCH may be REs chosen and indicated by the base station, e.g., based on channel conditions associated with the REs. In some cases, the base station may allocate information bits to DCI portions (e.g., such that HARQ parameters may be transmitted on a DCI portion that is located in a relatively reliable portion of the channel bandwidth) and may transmit the allocation information to the UE 115-a (e.g., before transmitting the DCI, either explicitly or implicitly). Additionally or alternatively, the UE may determine the mapping locations based on receiving, from the base station, an indication of a starting RE for a first DCI portion and a constant offset (e.g., frequency increments of x₁-x₂) of subsequent REs for remaining DCI portions. In some examples, the mapped locations may be uniformly spread, for instance, within a part of the total bandwidth of the set of PDSCH resources. In some cases, the portions may be uniformly spread across the total bandwidth of the set of PDSCH resources.

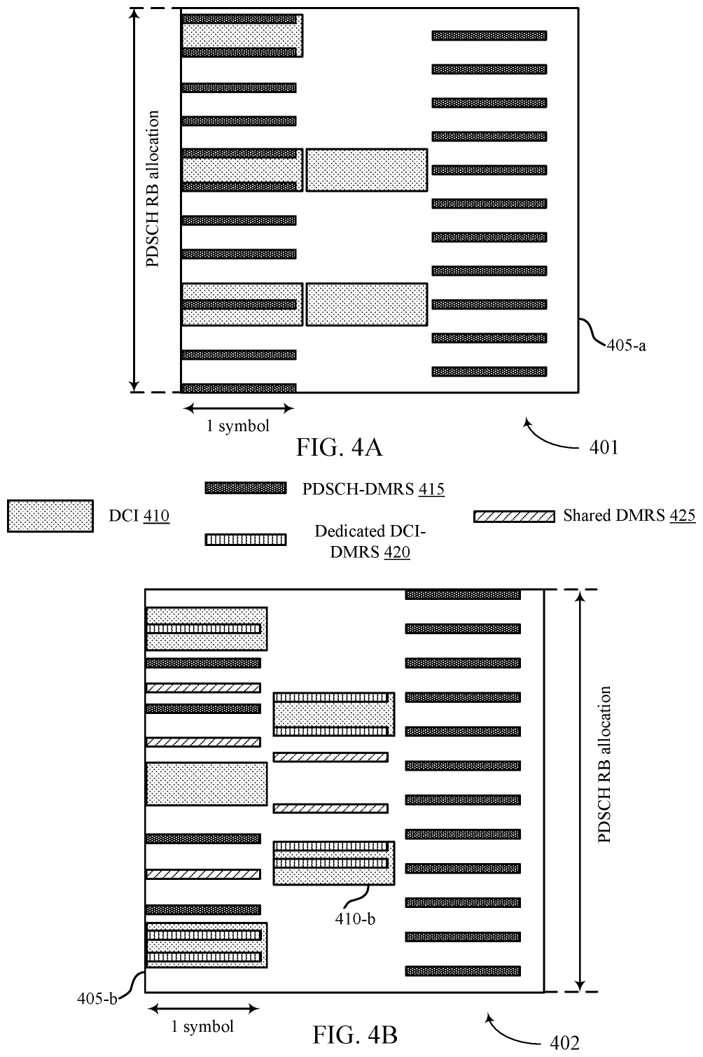

FIGS. 4A and 4B illustrate examples of resource allocation configurations 401 and 402 that support frequency multiplexing for control information over shared channel resources in accordance with aspects of the present disclosure. In some examples, the resource allocation configurations 401 and 402 may implement aspects of the wireless communications system 100 or wireless communications system 200. For example, the resource allocation configurations 401 and 402 may be implemented by a UE 115 and a base station 105, as described with reference to FIGS. 1 and 2.

As described herein, a base station may transmit a control message to a UE including an indication of frequency multiplexing of one or more portions of DCI 410 over a set of PDSCH resources (e.g., a PDSCH RB allocation) within a PDSCH occasion 405. The base station and the UE may determine a frequency multiplexing configuration for the DCI 410 within the set of PDSCH resources. For instance, the base station may assign DCI portions to one or more PDSCH RB allocations corresponding to one or more PDSCH symbols. That is, the base station may multiplex portions of DCI 410 in a PDSCH occasion 405 by allocating resources of the set of PDSCH resources for the DCI 410. The base station may transmit, and the UE may monitor for and receive, the DCI 410 over the set of PDSCH resources based on the resource allocation.

In some instances, the base station may transmit, and the UE may receive, one or more downlink reference signals (e.g., DMRSs 415, 420, and 425) associated with the DCI 410 over the set of PDSCH resources. The base station may allocate resources of the set of PDSCH resources for the DMRSs according to the resource allocation configurations 401 or 402. The UE may perform channel estimation for the multiplexed DCI 410, the set of PDSCH resources, or both, based on the DMRSs. The UE may receive the DMRSs used for channel estimation in one or more REs of the DCI 410, in resources of the set of PDSCH resources, or both. In some cases, the UE may receive DMRSs that are for the set of PDSCH resources (e.g., are not dedicated for the DCI 410), which may be referred to as PDSCH-DMRSs 415. Alternatively, the UE may receive DMRSs that are dedicated for the DCI 410, which may be referred to as DCI-DMRSs 420. The DCI-DMRSs 420 may be received on an RE of a portion of the DCI 410, on an RE outside of a portion of the DCI 410, or both. In some examples, DMRSs associated with the DCI 410 that are received outside of a portion of the DCI 410 may be dynamically configured to be dedicated for the DCI 410, for the set of PDSCH resources, or both; such DMRSs may be referred to as shared DMRSs 425.

The location (e.g., the resource allocation) of the DMRSs associated with the DCI 410 may be determined based on the frequency multiplexing configuration. For example, the base station may transmit DCI-DMRSs 420 in one or more REs of one or more portions of the DCI 410, such that the UE may accurately perform channel estimation for the DCI 410. Additionally, or alternatively, the base station may transmit, and the UE may receive, one or more DMRSs in a set of resources that overlaps with the resources used to transmit the DCI 410. In some examples, the base station may front-load one or more DMRSs in the PDSCH occasion 405, such that the one or more DMRSs are located in an initial one or more time resources (e.g., symbols, slots, or the like) of the set of PDSCH resources. In some cases, the base station may transmit the one or more DMRSs in each (e.g., every) symbol of the set of PDSCH resources, and may transmit an indication thereof to the UE.

In some cases, the base station may transmit, and the UE may receive, DMRSs according to a signal density, a spacing (e.g., a uniform spacing), a set of precoding parameters, or the like. In some examples, the signal density or the spacing may be different between DMRSs, e.g., based on whether the DMRS is a DCI-DMRS 420 or a PDSCH-DMRS 415, or based on the location of the DMRS in the set of PDSCH resources. As an example, DCI-DMRSs 420 may be transmitted according to a first signal density and a first spacing that is different than a second signal density and a second spacing for PDSCH-DMRSs 415. In another example, DMRSs transmitted in a portion of the DCI 410 may be transmitted according to a first signal density, a first uniform spacing, and a first set of precoding parameters, and DMRSs transmitted outside of a portion of the DCI 410 may be transmitted according to a second signal density, a second uniform spacing, and a second set of precoding parameters. In yet another example, the set of precoding parameters associated with a DMRS may be different for DMRSs transmitted in the same symbol or between symbols. For instance, the base station may adapt precoding parameters to channel conditions associated with REs of one or more portions of the DCI 410, such that a DCI-DMRS 420 transmitted in a first portion of the DCI 410 may be transmitted according to a first set of precoding parameters that is different than a second set of precoding parameters used to transmit a DCI-DMRS 420 transmitted in a second portion of the DCI 410.

The UE may receive the DMRSs transmitted by the base station and may use the DMRSs to perform channel estimation for the DCI 410, the set of PDSCH resources, or both. In some examples, the UE may perform channel estimation based on the location of the DMRSs and whether the DMRSs are DCI-DMRSs 420, PDSCH-DMRSs 415, or shared DMRSs 425. For instance, the UE may receive, in a first PDSCH symbol that includes DCI 410, one or more PDSCH-DMRSs 415 and one or more DCI-DMRSs 420. The UE may perform channel estimation for the first PDSCH symbol based on the one or more PDSCH-DMRSs 415 and may perform channel estimation for the DCI 410 based on the one or more DCI-DMRSs 420. In some cases, the UE may perform channel estimation for symbols that do not include a DMRS based on channel estimation performed for nearby symbols that do include a DMRS, e.g., by interpolating between channel estimation results or between DMRSs.

FIG. 4A illustrates a resource allocation configuration 401 for a set of PDSCH resources of a PDSCH occasion 405-a, where the set of PDSCH resources includes portions of DCI 410 to be multiplexed in the frequency domain. The portions of the DCI 410 may be transmitted (e.g., according to a frequency multiplexing configuration) in two symbols of the PDSCH occasion 405-a. Resource allocation configuration 401 also includes a number of PDSCH-DMRSs 415. The PDSCH-DMRSs 415 may be transmitted by the base station to be used by the UE for performing channel estimation for the set of PDSCH resources, e.g., for the PDSCH occasion 405-a. However, in some examples, the PDSCH-DMRSs 415 may also function as DCI-DMRSs, in that the UE may perform channel estimation for the DCI 410 based on the PDSCH-DMRSs 415.

The PDSCH-DMRSs 415 may be present in symbols where portions of the DCI 410 are located. For example, the PDSCH-DMRSs 415 may be located in a set of frequency resources that overlaps with resources used to transmit portions of the DCI 410, as illustrated in FIG. 4A where the portions of the DCI 410 transmitted in the first symbol of the PDSCH occasion 405-a overlap in the frequency domain with PDSCH-DMRSs 415. Alternatively, the PDSCH-DMRSs 415 may be present in symbols that include portions of the DCI 410, but may located in a set of frequency resources that does not overlap with resources used to transmit the portions of the DCI 410. In some examples, the PDSCH-DMRSs 415 may be transmitted in each (e.g., every) symbol of the set of PDSCH resources. In such examples, the UE may receive an indication that one or more reference signals (e.g., PDSCH DMRSs 415) are located in each symbol of the set of PDSCH resources.

In some instances, PDSCH-DMRSs 415 may not be present in one or more PDSCH symbols. For example, if frequency hopping of DCI within PDSCH is not activated, PDSCH-DMRSs 415 may not be received in one or more PDSCH symbols. As illustrated in FIG. 4A, the first symbol of the PDSCH occasion 405-a includes PDSCH-DMRSs 415, while the second symbol of the PDSCH occasion 405-a does not. In such examples, the UE may perform channel estimation for a symbol or for DCI 410 received in a symbol that does not include DMRSs based on DMRSs received in a different symbol. For instance, the UE may use PDSCH-DMRSs 415 received in the first symbol to perform channel estimation for the DCI 410 received in the second symbol. Alternatively, the UE may use PDSCH-DMRSs 415 from a previous PDSCH symbol for channel estimation. For example, the UE may use PDSCH-DMRSs transmitted in the first symbol of the PDSCH occasion 405-a to perform channel estimation for the second symbol. Additionally or alternatively, the UE may use future PDSCH-DMRS for channel estimation (e.g., a DMRS from the third symbol).

FIG. 4B illustrates a resource allocation configuration 402 for a set of PDSCH resources of a PDSCH occasion 405-b, where the set of PDSCH resources includes portions of DCI 410 to be multiplexed in the frequency domain. The portions of the DCI 410 may be transmitted (e.g., according to a frequency multiplexing configuration) in two symbols of the PDSCH occasion 405-b. Resource allocation configuration 402 also includes a number of PDSCH-DMRSs 415, DCI-DMRSs 420, and shared DMRSs 425. As described herein, a dedicated DMRS may include DCI-DMRS 420, PDSCH-DMRS 415, or both, where the dedicated DMRS may be used for corresponding channel estimation (e.g., a DCI-DMRS 420 may be used for DCI channel estimation, while a PDSCH-DMRS 415 may be used for PDSCH channel estimation), and a shared DMRS 425 may be shared among DCI and PDSCH (e.g., may be used for channel estimation for either or both DCI and PDSCH). The DCI-DMRSs 420 may be transmitted by the base station to be used by the UE for performing channel estimation for the DCI 410, while the shared DMRSs 425 may be configured to function as PDSCH-DMRSs or DCI-DMRSs, or both (e.g., shared DMRS 425), in that the UE may perform channel estimation for the DCI 410, the PDSCH occasion 405-b, or both based on the shared DMRSs 425. For example, the base station may configure the shared DMRSs 425 to be used as PDSCH-DMRSs, and the UE may perform channel estimation for the PDSCH occasion 405-b based on the shared DMRSs 425. Alternatively, the base station may configure the shared DMRSs 425 to be used as DCI-DMRSs, and the UE may perform channel estimation for the DCI 410 based on the shared DMRSs 425.

Dedicated DCI-DMRS 420 shared DMRSs 425 may be present both in REs allocated to portions of DCI 410 and other REs within the PDSCH occasion 405-b (e.g., between the portions of DCI 410, as illustrated in FIG. 4B). Further, the density of the dedicated DCI-DMRS 420 transmitted inside the portions of DCI 410 may differ from dedicated DCI-DMRS 420 or shared DMRSs 425 transmitted outside the portions of DCI 410. For example, the base station may transmit DCI-DMRSs 420 outside of the DCI 410 with a lower signal density than DCI-DMRSs 420 transmitted within the DCI 410, such that channel estimation for the DCI 410 may be improved at the edges of portions of the DCI 410 while adding minimum overhead. In some examples, the base station may transmit shared DMRSs 425 outside of the DCI 410 and DCI-DMRS 420 inside the DCI 410 to achieve the same function.

In some cases, the DCI-DMRSs 420 may use different precoding parameters than PDSCH-DMRSs 415. In some cases, the precoding parameters may change between the portions of DCI 410 multiplexed on a same symbol; in such cases, each respective DCI-DMRS 420 may be transmitted according to the same precoding parameters as the associated portion of the DCI 410. Adapting to changes in precoding parameters may improve network performance (e.g., as the precoding parameters may be changed based on interference or poor channel conditions in the REs of each DCI portion 410). Based on the precoding parameters, the base station 105-a may allocate dedicated DCI-DMRS 420 to the associated portions of DCI 410. The UE 115-a may receive each portion of DCI 410 according to a respective set of precoding parameters, where each of the sets of precoding parameters may be different, and may receive the associated DCI-DMRSs 420

The UE 115-a may perform channel estimation for one or more symbols of the set of PDSCH resources, the DCI 410, or both, based on the corresponding DMRSs received based on the resource allocation 402. For example, the UE may perform channel estimation for the first symbol based on the PDSCH-DMRSs 415 received in the first symbol. In some cases, the UE may perform channel estimation for a symbol based on DMRSs received in a different symbol. In the example of FIG. 4B, the UE may perform channel estimation for the second symbol based on PDSCH-DMRSs 415 received in the first symbol, the third symbol or both. Likewise, the UE may perform channel estimation for a portion of DCI 410 based on DCI-DMRSs 420 received in other portions of DCI 410. For instance, the UE may interpolate between two portions of DCI 410 that included DCI-DMRSs 420 and may obtain an interpolated set of reference signals to use for channel estimation for the portion of DCI 410 that did not include DCI-DMRSs 420.

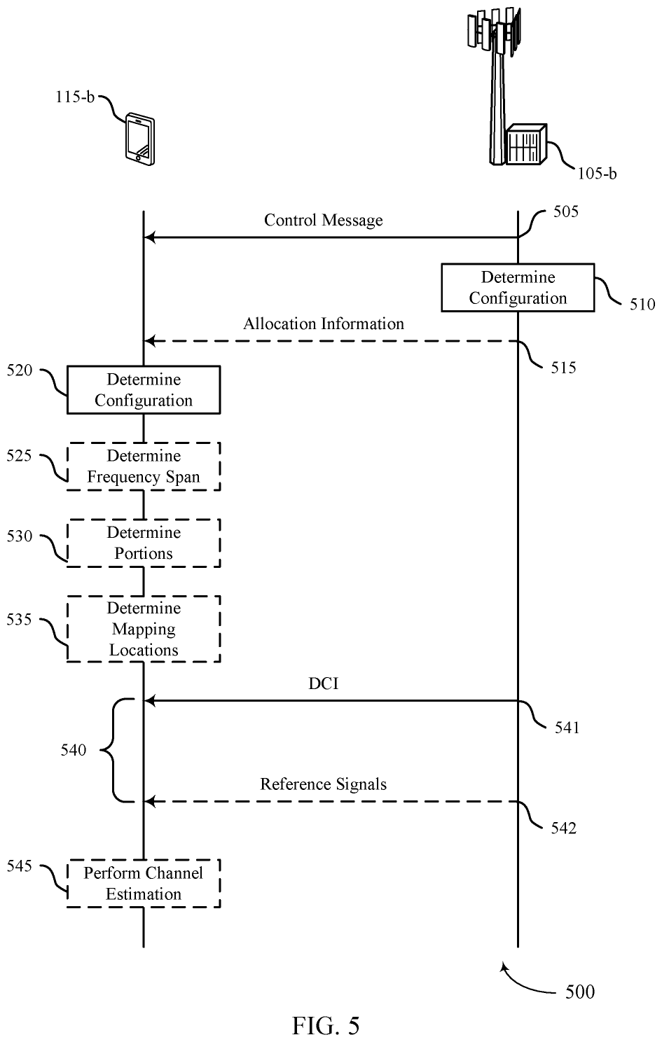

FIG. 5 illustrates an example of a process flow 500 that supports frequency multiplexing for control information over shared channel resources in accordance with aspects of the present disclosure. that supports frequency multiplexing of DCI inside shared downlink channels (e.g., PDSCH) in accordance with aspects of the present disclosure. In some examples, the process flow 500 may implement aspects of wireless communication system 100. For example, process flow 500 may include a base station 105-b and a UE 115-b, which may be examples of corresponding wireless devices as described herein. In the following description of the process flow 500, the operations between the UE 115-b and the base station 105-b may be transmitted in a different order than the order shown, or the operations performed by the UE 115-b and the base station 105-b may be performed in different orders or at different times. Certain operations may also be left out of the process flow 500, or other operations may be added to the process flow 500. While the UE 115-b and the base station 105-b are shown performing operations of process flow 500, any wireless device may perform the operations shown. Further, while FIG. 5 illustrates an example of communications between a UE 115-b and a base station 105-b, the techniques described herein may be applied to communications between any number of wireless devices.

The base station 105-b and the UE 115-b may communicate via a communication link, which may be an example of a control channel (e.g., PDCCH, PUCCH), a shared channel (e.g., PDSCH, PUSCH), or the like.

At 505, the base station 105-b may transmit, and the UE 115-b may receive, (e.g., via a downlink control channel, such as a PDCCH, or a downlink shared channel, such as a PDSCH) a control message (e.g., DCI, RRC, MAC-CE, among other examples). The control message may indicate (e.g., may include an indication) frequency multiplexing for DCI within a set of downlink shared channel resources (e.g., PDSCH resources) of one or more downlink shared channel occasions (e.g., PDSCH occasions) for the UE 115-b. In some cases, the control message may indicate frequency multiplexing of DCI for SPS-PDSCH. In some cases, the control message may include an indication of a first mapping location and an offset of DCI.

At 510, the base station 105-b may determine a frequency multiplexing configuration for the DCI over the set of downlink shared channel resources. In some examples, the base station 105-b may determine the frequency multiplexing configuration based on the control message transmitted at 505. In some cases, the base station 105-b may determine a size of each portion of the DCI. In some cases, the base station 105-b may optionally determine a set of multiplexing parameters corresponding to one of a set of REs, an initial RE, an offset, a uniformly spread pattern, or any combination thereof for the DCI. In some cases, the frequency multiplexing configuration may include the first mapping location and an offset for the DCI.

At 515, the base station 105-b may optionally transmit, to the UE 115-b, a message that indicates allocation information for one or more portions of the DCI. The allocation information may include a type of information included in the one or more portions of the DCI. Based on the transmission, the UE 115-b may receive the message that indicates allocation information corresponding to the frequency multiplexed DCI over the set of downlink shared channel resources.

At 520, the UE 115-b may determine a frequency multiplexing configuration for the DCI over the set of downlink shared resources. In some cases, the UE 115-b may determine the frequency multiplexing configuration based on the control message received at 505 and, in some examples, the allocation information received at 515. For example, the allocation information received at 515 may indicate a starting RE and an offset from which the UE 115-b may determine a frequency multiplexing mapping of DCI across the one or more downlink shared channel occasions.

In some examples, the UE 115-b may determine the frequency multiplexing configuration based on a frequency multiplexing pattern. For example, the UE 115-b may receive a message (e.g., transmitted by the base station 105-b) indicating that frequency hopping is activated for the DCI and may determine an offset for a frequency multiplexing pattern, which may be for the frequency multiplexing pattern.

At 525, the UE 115-b may determine a frequency span for the DCI. The frequency span may correspond to a number of REs per symbol of the DCI and may be for multiplexing the DCI within the set of downlink shared channel resources. For example, the DCI may include six total REs, and the frequency span may include three REs per symbol.

At 530, the UE 115-b may determine a number of portions of the DCI to be multiplexed in a first symbol of the PDSCH. The UE 115-b may determine the number of portions based on a number of REs per symbol, a number of available RE locations within the set of downlink shared channel resources, a content of the DCI to be multiplexed in the first symbol, or any combination thereof.

At 535, the UE 115-b may determine mapping locations for the number of portions of the DCI to be multiplexed in the first symbol. The UE 115-b may determine the mapping locations based on the number of portions (e.g., as determined at 535) and the frequency multiplexing configuration (e.g., as determined at 520). In some cases, the mapping locations may correspond to REs indicated by the frequency multiplexing configuration. In some cases, the UE 115-b may determine the first mapping location for a first portion of the DCI based on a starting RE index in the first symbol. In some cases, the UE 115-b may determine a second mapping location for a second portion of the DCI based on an offset and the first mapping location. In some examples, the frequency multiplexing configuration may include an indication of the first mapping location and the offset. In some cases, the UE 115-b may determine the mapping locations are uniformly spread within a bandwidth of the first symbol.

At 540, during the one or more downlink shared channel monitoring occasions, the base station 105-b may transmit, and the UE 115-b may monitor for and receive, the DCI over the set of downlink shared channel resources in accordance with the frequency multiplexing configuration. In some cases, the UE 115-b may monitor the shared channel occasion(s) based on the number of portions of DCI, the number of REs per symbol (e.g., frequency span) of the DCI, or both. Additionally, during the one or more downlink shared channel monitoring occasions, the base station 105-b may transmit, and the UE 115-b may receive, one or more downlink reference signals associated with the DCI within the set of downlink shared channel resources.

For example, at 541, the base station 105-b may transmit the DCI to the UE 115-b over the set of downlink shared channel resources in accordance with the frequency multiplexing configuration. In some cases, the base station 105-b may transmit, and the UE 115-b may receive, each portion of the DCI (e.g., as determined at 530) according to a respective set of precoding parameters, where each set of precoding parameters may be different. In some examples, the base station 105-b may transmit, and the UE 115-b may receive, the DCI based on an offset for a frequency multiplexing pattern for the frequency multiplexing configuration.

At 542, the base station 105-b may transmit, and the UE 115-b may monitor for (e.g., during the downlink shared channel occasion(s)) and receive, one or more reference signals (e.g., downlink reference signals, such as DMRSs) associated with the DCI within the set of downlink shared channel resources. The one or more reference signals may be dedicated for the DCI, dedicated for the set of downlink shared channel resources, or some combination thereof. Additionally, the one or more reference signals—whether dedicated for the DCI, dedicated for the set of downlink shared channel resources, or both—may be received in a portion of the DCI (i.e., in one or more resource elements in a portion of the DCI), in one or more resources (e.g., time resource(s), frequency resource(s)) of the set of downlink shared channel resources, or some combination thereof. As a non-limiting example, the UE 115-b may receive reference signals in a first symbol of the set of downlink shared channel resources, where a first set of the reference signals may be dedicated for the set of downlink shared channel resources and a second set of the reference signals may be dedicated for the DCI.

The one or more reference signals may be located in the set of downlink shared channel resources, in one or more resource elements of the DCI, or both. For example, the base station 105-b may transmit, and the UE 115-b may receive, reference signals in one or more REs, where the one or more REs are in one or more portions of the DCI. In some cases, the UE 115-b may receive respective sets of reference signals for each portion of the DCI. Additionally or alternatively, the UE 115-b may receive reference signals in a symbol (e.g., a first symbol) of the downlink shared channel resources. In some examples, the UE 115-b may receive, from the base station 105-b, an indication of the location of the one or more reference signals; for instance, the UE 115-b may receive an indication that the one or more reference signals are located in each symbol of the set of downlink shared channel resources. In some cases, the UE 115-b may receive a first set of reference signals (e.g., dedicated for the DCI) on a first set of REs in one or more portions of the DCI and a second set of reference signals (e.g., dedicated for the DCI) on a second set of REs (e.g., of the set of downlink shared channel resources).

As another example, the UE 115-b may receive reference signals in one or more sets of frequency resources in the set of downlink shared channel resources, one or more sets of time resources in the set of downlink shared channel resources, or some combination thereof. For instance, at least one reference signal of the one or more reference signals may be located in a first set of frequency resources (e.g., of the set of downlink shared channel resources used for the DCI), where the first set overlaps with a second set of frequency resources (e.g., of the set of downlink shared channel resources used for the DCI). Alternatively, the first set may be non-overlapping with the second set. In some cases, the UE 115-b may receive the one or more reference signals in an initial set of time resources of the set of downlink shared channel resources

In some examples, the base station 105-b may transmit, and the UE 115-b may receive, the one or more reference signals according to a reference signal density, a spacing (e.g., a uniform spacing), one or more precoding parameters, or some combination thereof. In some cases, the reference signal density, spacing, or precoding parameters may not be the same for all of the one or more reference signals. For example, the UE 115-b may receive a first set of reference signals according to a first reference signal density, a first uniform spacing, and a first set of precoding parameters, and the UE 115-b may receive a second set of reference signals according to a second reference signal density, a second uniform spacing, and a second set of precoding parameters. In some cases, the UE 115-b may receive (e.g., at 540) each portion of the DCI according to a respective set of precoding parameters and may receive respective sets of reference signals for each portion of the DCI based on the respective sets of precoding parameters. That is, the set of precoding parameters may change for each portion of the DCI, and the set of precoding parameters may therefore change for the associated reference signals.

At 545, if the UE 115-b received one or more reference signals associated with the DCI (e.g., at 542), the UE 115-b may perform channel estimation. The UE 115-b may perform channel estimation for the DCI, for the set of downlink shared channel resources, or some combination thereof. In some examples, the UE 115-b may perform channel estimation based on whether the one or more reference signals were dedicated for the DCI, the set of downlink shared channel resources, or both. For example, if the UE 115-b receives reference signals for the set of downlink shared channel resources in a symbol of the set of downlink shared channel resources, the UE 115-b may perform channel estimation for that symbol (e.g., based on the reference signals). Alternatively, if the UE 115-b receives reference signals dedicated for the DCI in one or more REs of the DCI, the UE 115-b may perform channel estimation for the DCI (e.g., based on the reference signals). It should be noted that the examples described herein are not limiting, and that the UE 115-b may perform channel estimation for any combination of reference signals received in any combination of locations. For instance, if the UE 115-b receives reference signals dedicated for the set of downlink shared channel resources, the UE 115-b may still perform channel estimation for the DCI based on the reference signals (e.g., although the reference signals are dedicated for the set of downlink shared channel resources).

As an example, the UE 115-b may perform channel estimation for a first symbol of the set of downlink shared channel resources based at least in part on one or more reference signals received in the first symbol. Additionally or alternatively, the UE 115-b may perform channel estimation for another symbol of the set of downlink shared channel resources based the on one or more reference signals. For instance, the UE 115-b may receive reference signals in the first symbol, and may perform channel estimation for a second symbol based on the reference signals received in the first symbol. As another example, the UE 115-b may receive one or more reference signals in one or more REs in a first portion of the DCI and one or more reference signals in one or more REs in a second portion of the DCI. The UE 115-b may interpolate between the first portion and the second portion and may obtain a set of interpolated reference signals. The UE 115-b may use the interpolated reference signals to perform channel estimation for the DCI. In some cases, the UE 115-b may interpolate reference signals to perform channel estimation for a resource (e.g., a portion of the DCI, a symbol of the set of downlink shared channel resources, or the like) in which the UE 115-b did not receive a reference signal. For example, the UE 115-b may receive the first portion of the DCI in a first symbol, the second portion of the DCI in a second symbol, and a third portion of the DCI in a third symbol, where the third portion of the DCI excludes any reference signals. The UE 115-b may perform channel estimation for third symbol based on interpolating between the reference signals received in the first symbol and the second symbol.

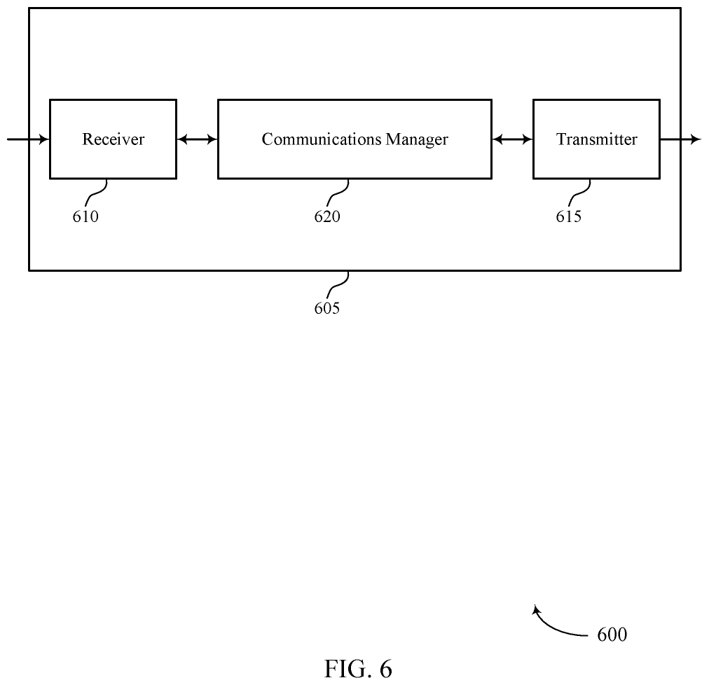

FIG. 6 shows a block diagram 600 of a device 605 that supports frequency multiplexing for control information over shared channel resources in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to frequency multiplexing for control information over shared channel resources). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to frequency multiplexing for control information over shared channel resources). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of frequency multiplexing for control information over shared channel resources as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for receiving a control message that indicates frequency multiplexing for downlink control information within a set of downlink shared channel resources of a downlink shared channel occasion. The communications manager 620 may be configured as or otherwise support a means for determining a frequency multiplexing configuration for the downlink control information over the set of downlink shared channel resources based on the control message. The communications manager 620 may be configured as or otherwise support a means for monitoring the downlink shared channel occasion for the downlink control information in accordance with the frequency multiplexing configuration.

By including or configuring the communications manager 620 in accordance with examples as described herein, the device 605 (e.g., a processor controlling or otherwise coupled to the receiver 610, the transmitter 615, the communications manager 620, or a combination thereof) may support reducing power consumption and increasing overall signal reliability by receiving DCI over PDSCH according to a frequency multiplexing configuration. Frequency multiplexing DCI over PDSCH may enable the device 705 to adapt to suboptimal signal conditions (e.g., interference, deep fading) by increasing frequency diversity and communications reliability. Further, receiving downlink reference signals according to the techniques described herein may enable the device 705 to increase the reliability of the DCI (e.g., by using downlink reference signals dedicated for DCI), reduce signaling overhead (e.g., by using downlink reference signals for both downlink shared channel resources and DCI), or both, which may in turn result in more efficient utilization of communication resources.

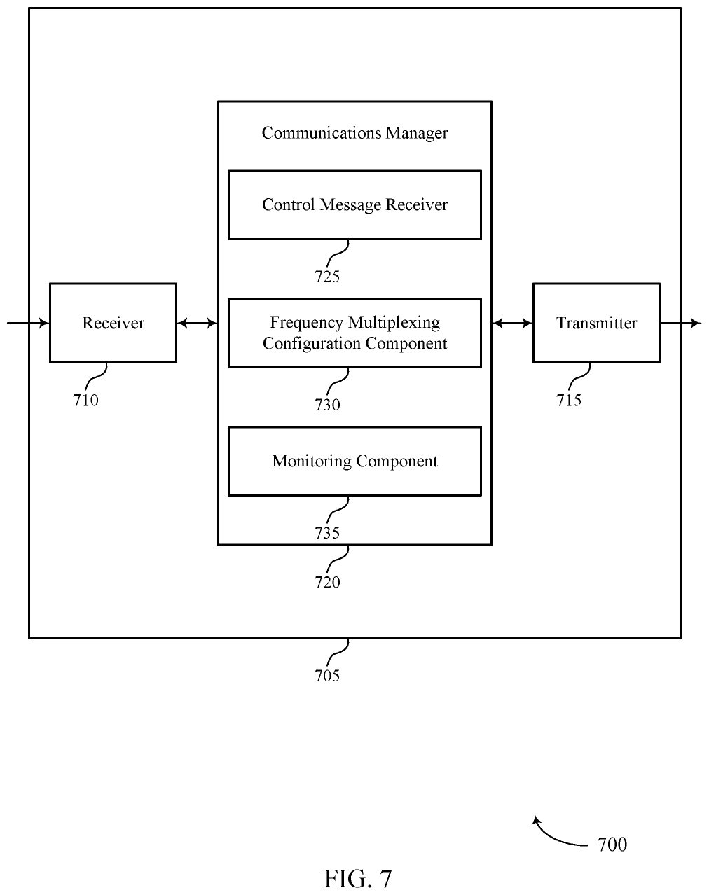

FIG. 7 shows a block diagram 700 of a device 705 that supports frequency multiplexing for control information over shared channel resources in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to frequency multiplexing for control information over shared channel resources). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to frequency multiplexing for control information over shared channel resources). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of frequency multiplexing for control information over shared channel resources as described herein. For example, the communications manager 720 may include a control message receiver 725, a frequency multiplexing configuration component 730, a monitoring component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The control message receiver 725 may be configured as or otherwise support a means for receiving a control message that indicates frequency multiplexing for DCI within a set of downlink shared channel resources of a downlink shared channel occasion. The frequency multiplexing configuration component 730 may be configured as or otherwise support a means for determining a frequency multiplexing configuration for the DCI over the set of downlink shared channel resources based on the control message. The monitoring component 735 may be configured as or otherwise support a means for monitoring the downlink shared channel occasion for the DCI in accordance with the frequency multiplexing configuration.

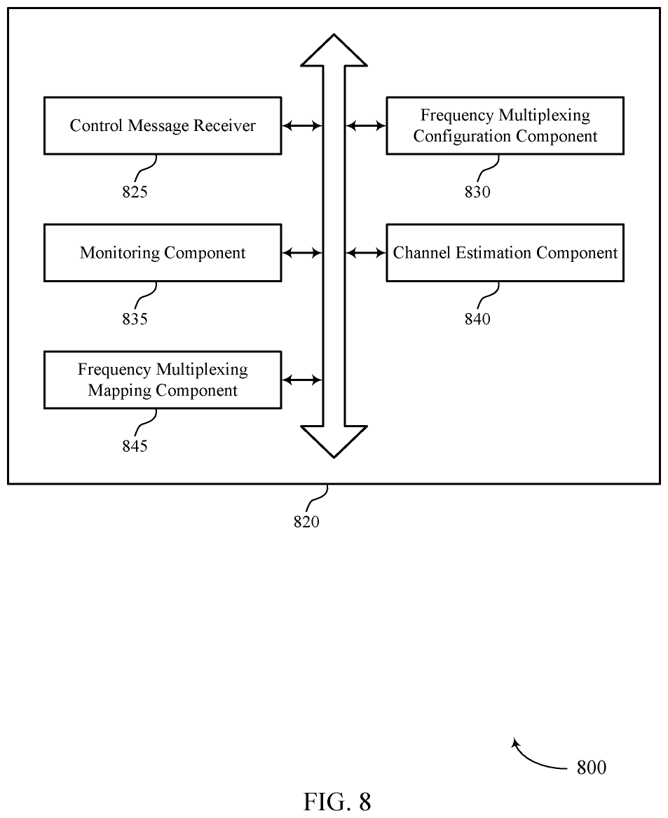

FIG. 8 shows a block diagram 800 of a communications manager 820 that supports frequency multiplexing for control information over shared channel resources in accordance with aspects of the present disclosure. The communications manager 820 may be an example of aspects of a communications manager 620, a communications manager 720, or both, as described herein. The communications manager 820, or various components thereof, may be an example of means for performing various aspects of frequency multiplexing for control information over shared channel resources as described herein. For example, the communications manager 820 may include a control message receiver 825, a frequency multiplexing configuration component 830, a monitoring component 835, a channel estimation component 840, a frequency multiplexing mapping component 845, or any combination thereof. Each of these components may communicate, directly or indirectly, with one another (e.g., via one or more buses).

The communications manager 820 may support wireless communications at a UE in accordance with examples as disclosed herein. The control message receiver 825 may be configured as or otherwise support a means for receiving a control message that indicates frequency multiplexing for DCI within a set of downlink shared channel resources of a downlink shared channel occasion. The frequency multiplexing configuration component 830 may be configured as or otherwise support a means for determining a frequency multiplexing configuration for the DCI over the set of downlink shared channel resources based on the control message. The monitoring component 835 may be configured as or otherwise support a means for monitoring the downlink shared channel occasion for the DCI in accordance with the frequency multiplexing configuration.

In some examples, the frequency multiplexing configuration component 830 may be configured as or otherwise support a means for determining a frequency span for the DCI, the frequency span corresponding to a number of resource elements per symbol for multiplexing of the DCI within the set of downlink shared channel resources, where monitoring the downlink shared channel occasion for the DCI is based on the number of resource elements per symbol. In some examples, the frequency multiplexing configuration component 830 may be configured as or otherwise support a means for determining a number of portions of the DCI to be multiplexed in a first symbol of the set of downlink shared channel resources based on a number of resource elements per symbol, a number of available resource element locations in the set of downlink shared channel resources, a content of the downlink control to be multiplexed in the first symbol, or any combination thereof, where monitoring the downlink shared channel occasion for the DCI is based on the number of portions of the DCI.

In some examples, the frequency multiplexing mapping component 845 may be configured as or otherwise support a means for determining mapping locations for the number of portions of the DCI to be multiplexed in the first symbol based on the number of portions and the frequency multiplexing configuration. In some examples, to support determining the mapping locations, the frequency multiplexing mapping component 845 may be configured as or otherwise support a means for determining a first mapping location for a first portion of the DCI based on a starting resource element index in the first symbol. In some examples, to support determining the mapping locations, the frequency multiplexing mapping component 845 may be configured as or otherwise support a means for determining a second mapping location for a second portion of the DCI based on an offset and the first mapping location.

In some examples, the frequency multiplexing configuration includes an indication of the first mapping location and the offset. In some examples, the mapping locations correspond to resource elements indicated by the frequency multiplexing configuration. In some examples, the mapping locations are uniformly spread within a bandwidth of the first symbol. In some examples, the control message receiver 825 may be configured as or otherwise support a means for receiving a message that indicates allocation information for one or more portions of DCI, the allocation information including a type of information included in the one or more portions of DCI.

In some examples, the monitoring component 835 may be configured as or otherwise support a means for receiving one or more reference signals associated with the DCI within the set of downlink shared channel resources. In some examples, the channel estimation component 840 may be configured as or otherwise support a means for performing channel estimation for the DCI based on the one or more reference signals.

In some examples, at least one reference signal of the one or more reference signals is located in a first set of frequency resources of the set of downlink shared channel resources that is non-overlapping with a second set of resources of the set of downlink shared channel resources used for the DCI. In some examples, at least one reference signal of the one or more reference signals is located in a first set of frequency resources of the set of downlink shared channel resources that is overlapping with a second set of resources of the set of downlink shared channel resources used for the DCI. In some examples, the one or more reference signals are located in an initial set of time resources of the set of downlink shared channel resources.

In some examples, the monitoring component 835 may be configured as or otherwise support a means for receiving an indication that the one or more reference signals are located in each symbol of the set of downlink shared channel resources. In some examples, the monitoring component 835 may be configured as or otherwise support a means for receiving, in a first symbol of the downlink shared channel resources, one or more reference signals for the set of downlink shared channel resources. In some examples, the channel estimation component 840 may be configured as or otherwise support a means for performing channel estimation for the first symbol based on the one or more reference signals. In some examples, the channel estimation component 840 may be configured as or otherwise support a means for performing channel estimation for a second symbol of the set of downlink shared channel resources based on the one or more reference signals.

In some examples, the monitoring component 835 may be configured as or otherwise support a means for receiving, in the first symbol of the downlink shared channel resources, one or more second reference signals dedicated for the DCI. In some examples, the channel estimation component 840 may be configured as or otherwise support a means for performing channel estimation for the DCI based on the one or more second reference signals.

In some examples, the monitoring component 835 may be configured as or otherwise support a means for receiving one or more reference signals in one or more resource elements in at least one portion of the DCI, where the one or more reference signals are dedicated for the DCI, the set of downlink shared channel resources, or both. In some examples, the channel estimation component 840 may be configured as or otherwise support a means for performing channel estimation for the DCI based on the one or more reference signals. In some examples, to support performing channel estimation, the channel estimation component 840 may be configured as or otherwise support a means for interpolating between the at least one portion and at least one other portion in which the one or more reference signals are received to obtain a set of interpolated reference signals, where the channel estimation is performed based on the set of interpolated reference signals.

In some examples, the monitoring component 835 may be configured as or otherwise support a means for receiving a first set of reference signals dedicated for the DCI on a first set of resource elements in one or more portions of the DCI. In some examples, the channel estimation component 840 may be configured as or otherwise support a means for performing channel estimation for the first symbol based on the first set of reference signals.

In some examples, the channel estimation component 840 may be configured as or otherwise support a means for receiving a second set of reference signals dedicated for the DCI on a second set of resource elements of the set of downlink shared channel resources, where the channel estimation is performed based on the first set of reference signals and the second set of reference signals. In some examples, the first set of reference signals is received according to a first reference signal density and a first uniform spacing and the second set of reference signals is received according to a second reference signal density and a second uniform spacing. In some examples, the first set of reference signals is received according to a first set of precoding parameters and the second set of reference signals is received according to a second set of precoding parameters.

In some examples, the control message receiver 825 may be configured as or otherwise support a means for receiving a message that indicates frequency hopping is activated for the DCI. In some examples, the frequency multiplexing configuration component 830 may be configured as or otherwise support a means for determining an offset for a frequency multiplexing pattern for the frequency multiplexing configuration. In some examples, the monitoring component 835 may be configured as or otherwise support a means for monitoring for the DCI based on the offset.

In some examples, the monitoring component 835 may be configured as or otherwise support a means for receiving each portion of the DCI according to a respective set of precoding parameters, where each of the respective sets of precoding parameters is different. In some examples, the monitoring component 835 may be configured as or otherwise support a means for receiving respective sets of reference signals for each portion of the DCI based on the respective sets of precoding parameters.

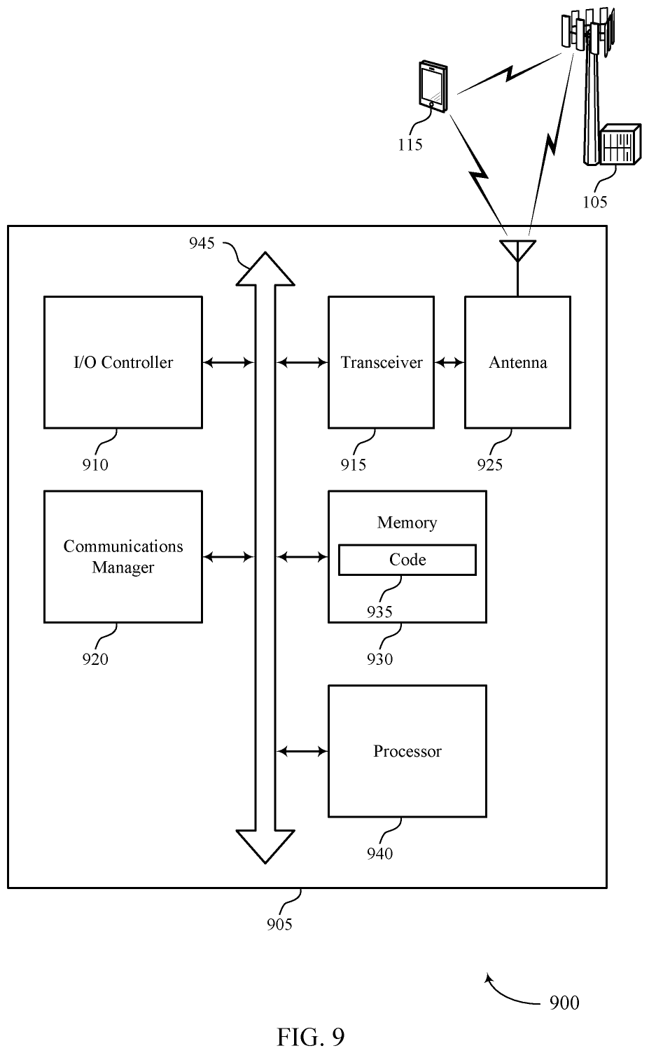

FIG. 9 shows a diagram of a system 900 including a device 905 that supports frequency multiplexing for control information over shared channel resources in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting frequency multiplexing for control information over shared channel resources). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving a control message that indicates frequency multiplexing for DCI within a set of downlink shared channel resources of a downlink shared channel occasion. The communications manager 920 may be configured as or otherwise support a means for determining a frequency multiplexing configuration for the DCI over the set of downlink shared channel resources based on the control message. The communications manager 920 may be configured as or otherwise support a means for monitoring the downlink shared channel occasion for the DCI in accordance with the frequency multiplexing configuration.

By including or configuring the communications manager 920 in accordance with examples as described herein, the device 905 may support techniques for receiving DCI over PDSCH according to a frequency multiplexing configuration. Receiving DCI (and, in some cases, downlink reference signals) on varying frequencies may increase frequency diversity, which may provide increased communications reliability. Further, the techniques described herein support flexibility in receiving downlink reference signals associated with the DCI, which may enable the device 905 to increase communications reliability, e.g., based on the information included in the DCI and the frequency multiplexing configuration. Enabling the device 905 to adaptively use downlink reference signals in accordance with the frequency multiplexing configuration may improve communications efficiency (e.g., by reducing signaling overhead). In some examples, the device 905 may be an example of a Redcap device, which may be associated with operating characteristics such as less downlink signaling (e.g., the device 905 may transmit relatively more uplink signaling and may receive relatively less downlink signaling), low complexity, and low power; in such examples, the device 905 may further benefit from decreased signaling overhead and power consumption associated with receiving DCI over PDSCH.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of frequency multiplexing for control information over shared channel resources as described herein, or the processor 940 and the memory 930 may be otherwise configured to perform or support such operations.

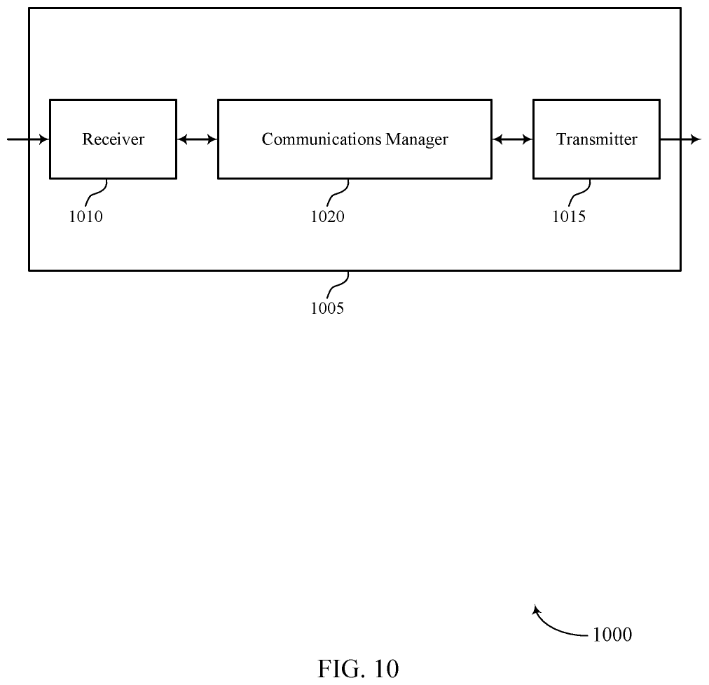

FIG. 10 shows a block diagram 1000 of a device 1005 that supports frequency multiplexing for control information over shared channel resources in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to frequency multiplexing for control information over shared channel resources). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to frequency multiplexing for control information over shared channel resources). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of frequency multiplexing for control information over shared channel resources as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for transmitting, to a UE, a control message that indicates frequency multiplexing for DCI within a set of downlink shared channel resources of a downlink shared channel occasion for the UE. The communications manager 1020 may be configured as or otherwise support a means for determining a frequency multiplexing configuration for the DCI over the set of downlink shared channel resources based on the control message. The communications manager 1020 may be configured as or otherwise support a means for transmitting the DCI over the set of downlink shared channel resources in accordance with the frequency multiplexing configuration.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support reduced power consumption and increased overall signal reliability by transmitting DCI over PDSCH according to a frequency multiplexing configuration. The device 1005 may therefore adapt to suboptimal signal conditions (e.g., interference, deep fading) by utilizing an increased beamforming gain associated with PDSCH transmissions and frequency diversity associated with frequency multiplexing. Further, reducing signaling overhead by transmitting DCI over PDSCH may provide efficient utilization of communication resources.

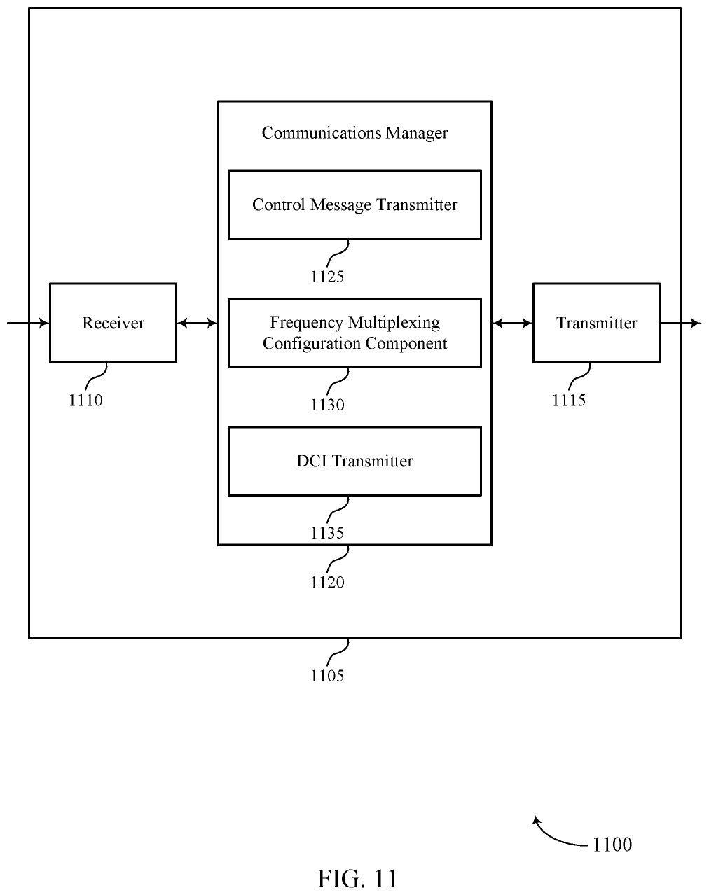

FIG. 11 shows a block diagram 1100 of a device 1105 that supports frequency multiplexing for control information over shared channel resources in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to frequency multiplexing for control information over shared channel resources). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to frequency multiplexing for control information over shared channel resources). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of frequency multiplexing for control information over shared channel resources as described herein. For example, the communications manager 1120 may include a control message transmitter 1125, a frequency multiplexing configuration component 1130, a DCI transmitter 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The control message transmitter 1125 may be configured as or otherwise support a means for transmitting, to a UE, a control message that indicates frequency multiplexing for DCI within a set of downlink shared channel resources of a downlink shared channel occasion for the UE. The frequency multiplexing configuration component 1130 may be configured as or otherwise support a means for determining a frequency multiplexing configuration for the DCI over the set of downlink shared channel resources based on the control message. The DCI transmitter 1135 may be configured as or otherwise support a means for transmitting the DCI over the set of downlink shared channel resources in accordance with the frequency multiplexing configuration.

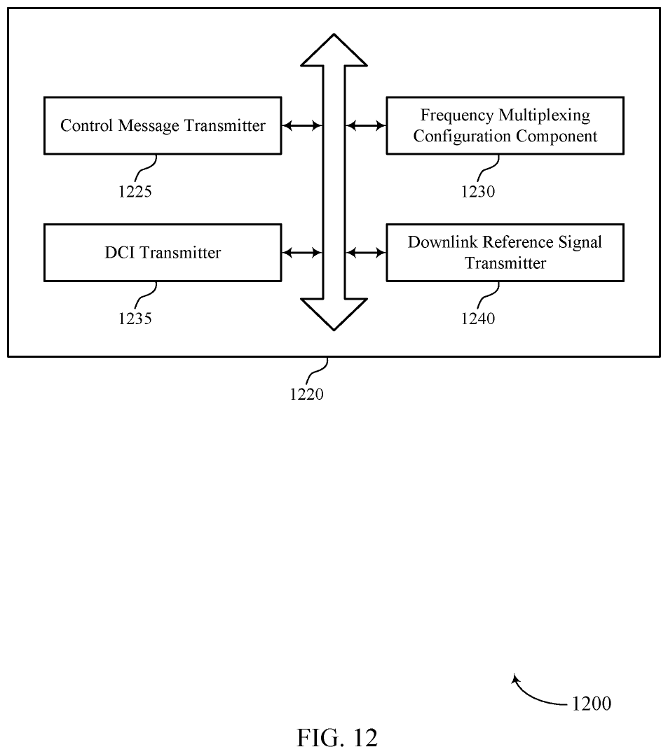

FIG. 12 shows a block diagram 1200 of a communications manager 1220 that supports frequency multiplexing for control information over shared channel resources in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of frequency multiplexing for control information over shared channel resources as described herein. For example, the communications manager 1220 may include a control message transmitter 1225, a frequency multiplexing configuration component 1230, a DCI transmitter 1235, a downlink reference signal transmitter 1240, or any combination thereof. Each of these components may communicate, directly or indirectly, with one another (e.g., via one or more buses).

The communications manager 1220 may support wireless communications at a base station in accordance with examples as disclosed herein. The control message transmitter 1225 may be configured as or otherwise support a means for transmitting, to a UE, a control message that indicates frequency multiplexing for DCI within a set of downlink shared channel resources of a downlink shared channel occasion for the UE. The frequency multiplexing configuration component 1230 may be configured as or otherwise support a means for determining a frequency multiplexing configuration for the DCI over the set of downlink shared channel resources based on the control message. The DCI transmitter 1235 may be configured as or otherwise support a means for transmitting the DCI over the set of downlink shared channel resources in accordance with the frequency multiplexing configuration.

In some examples, the control message transmitter 1225 may be configured as or otherwise support a means for transmitting a message that indicates frequency hopping is activated for the frequency for the DCI. In some examples, the frequency multiplexing configuration component 1230 may be configured as or otherwise support a means for determining an offset for a frequency multiplexing pattern for the frequency multiplexing configuration. In some examples, the DCI transmitter 1235 may be configured as or otherwise support a means for transmitting the DCI based on the offset.

In some examples, the control message transmitter 1225 may be configured as or otherwise support a means for transmitting a message that indicates allocation information for one or more portions of DCI, the allocation information including a type of information included in the one or more portions of DCI.

In some examples, the DCI transmitter 1235 may be configured as or otherwise support a means for transmitting one or more reference signals associated with the DCI within the set of downlink shared channel resources. In some examples, at least one reference signal of the one or more reference signals is located in a first set of frequency resources of the set of downlink shared channel resources that is non-overlapping with a second set of resources of the set of downlink shared channel resources used for the DCI. In some examples, at least one reference signal of the one or more reference signals is located in a first set of frequency resources of the set of downlink shared channel resources that is overlapping with a second set of resources of the set of downlink shared channel resources used for the DCI.

In some examples, the one or more reference signals are located in an initial set of time resources of the set of downlink shared channel resources. In some examples, the control message transmitter 1225 may be configured as or otherwise support a means for transmitting an indication that the one or more reference signals are located in each symbol of the set of downlink shared channel resources. In some examples, the downlink reference signal transmitter 1240 may be configured as or otherwise support a means for transmitting, in a first symbol of the downlink shared channel resources, one or more reference signals for the set of downlink shared channel resources. In some examples, the downlink reference signal transmitter 1240 may be configured as or otherwise support a means for transmitting, in the first symbol of the downlink shared channel resources, one or more second reference signals dedicated for the DCI.

In some examples, the downlink reference signal transmitter 1240 may be configured as or otherwise support a means for transmitting one or more reference signals in one or more resource elements in each portion of the DCI, where the one or more reference signals are dedicated for the DCI, the set of downlink shared channel resources, or both.

In some examples, the downlink reference signal transmitter 1240 may be configured as or otherwise support a means for transmitting a first set of reference signals dedicated for the DCI on a first set of resource elements in one or more portions of the DCI. In some examples, the downlink reference signal transmitter 1240 may be configured as or otherwise support a means for transmitting a second set of reference signals dedicated for the DCI on a second set of resource elements of the set of downlink shared channel resources. In some examples, the first set of reference signals is transmitted according to a first reference signal density and a first uniform spacing and the second set of reference signals is transmitted according to a second reference signal density and a second uniform spacing.

In some examples, the first set of reference signals is transmitted according to a first set of precoding parameters and the second set of reference signals is transmitted according to a second set of precoding parameters. In some examples, the DCI transmitter 1235 may be configured as or otherwise support a means for transmitting each portion of the DCI according to a respective set of precoding parameters, where each of the respective sets of precoding parameters is different. In some examples, the downlink reference signal transmitter 1240 may be configured as or otherwise support a means for transmitting respective sets of reference signals for each portion of the DCI based on the respective sets of precoding parameters.

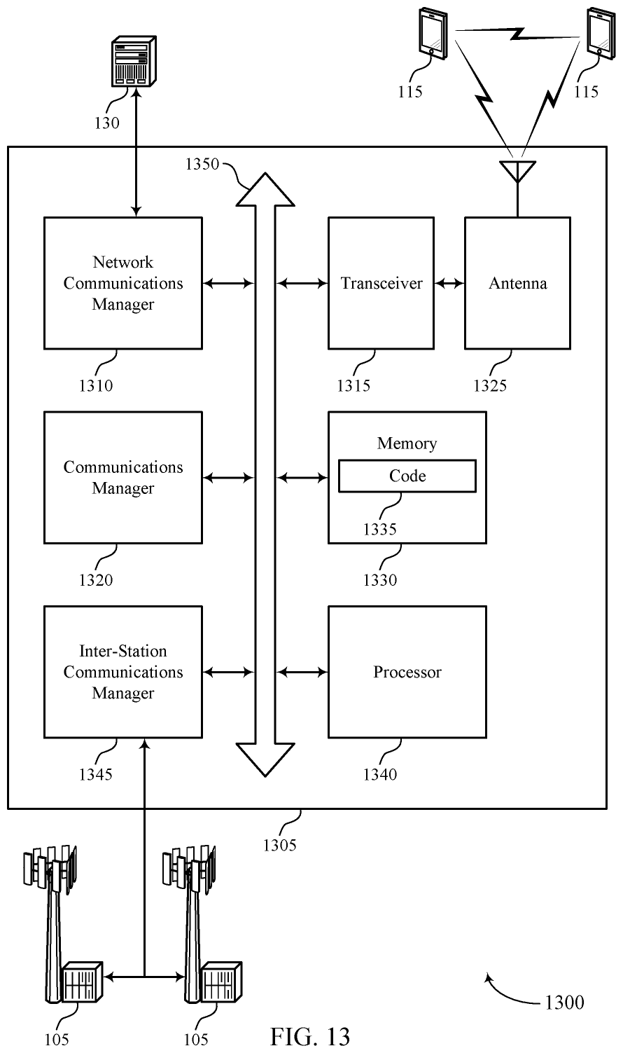

FIG. 13 shows a diagram of a system 1300 including a device 1305 that supports frequency multiplexing for control information over shared channel resources in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting frequency multiplexing for control information over shared channel resources). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for transmitting, to a UE, a control message that indicates frequency multiplexing for DCI within a set of downlink shared channel resources of a downlink shared channel occasion for the UE. The communications manager 1320 may be configured as or otherwise support a means for determining a frequency multiplexing configuration for the DCI over the set of downlink shared channel resources based on the control message. The communications manager 1320 may be configured as or otherwise support a means for transmitting the DCI over the set of downlink shared channel resources in accordance with the frequency multiplexing configuration.

By including or configuring the communications manager 1320 in accordance with examples as described herein, the device 1305 may support techniques for increasing overall signal reliability by using frequency multiplexing for DCI transmitted over PDSCH. For example, increased frequency diversity associated with frequency multiplexing may increase communications reliability, e.g., while some of the frequencies may suffer suboptimal signal conditions (e.g., interference, deep fading), others may not. Additionally, higher beamforming gains associated with PDSCH transmissions may further increase robustness. Increasing communications reliability may thereby result in more efficient utilization of communication resources and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of frequency multiplexing for control information over shared channel resources as described herein, or the processor 1340 and the memory 1330 may be otherwise configured to perform or support such operations.

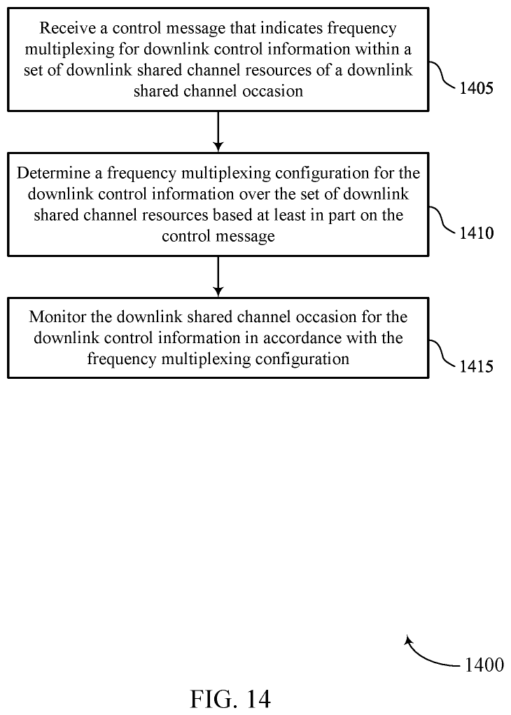

FIG. 14 shows a flowchart illustrating a method 1400 that supports frequency multiplexing for control information over shared channel resources in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving a control message that indicates frequency multiplexing for DCI within a set of downlink shared channel resources of a downlink shared channel occasion. The operations of 1405 may be performed in accordance with examples as disclosed herein. In some examples, aspects of the operations of 1405 may be performed by a control message receiver 825 as described with reference to FIG. 8.

At 1410, the method may include determining a frequency multiplexing configuration for the DCI over the set of downlink shared channel resources based on the control message. The operations of 1410 may be performed in accordance with examples as disclosed herein. In some examples, aspects of the operations of 1410 may be performed by a frequency multiplexing configuration component 830 as described with reference to FIG. 8. At 1415, the method may include monitoring the downlink shared channel occasion for the DCI in accordance with the frequency multiplexing configuration. The operations of 1415 may be performed in accordance with examples as disclosed herein. In some examples, aspects of the operations of 1415 may be performed by a monitoring component 835 as described with reference to FIG. 8.

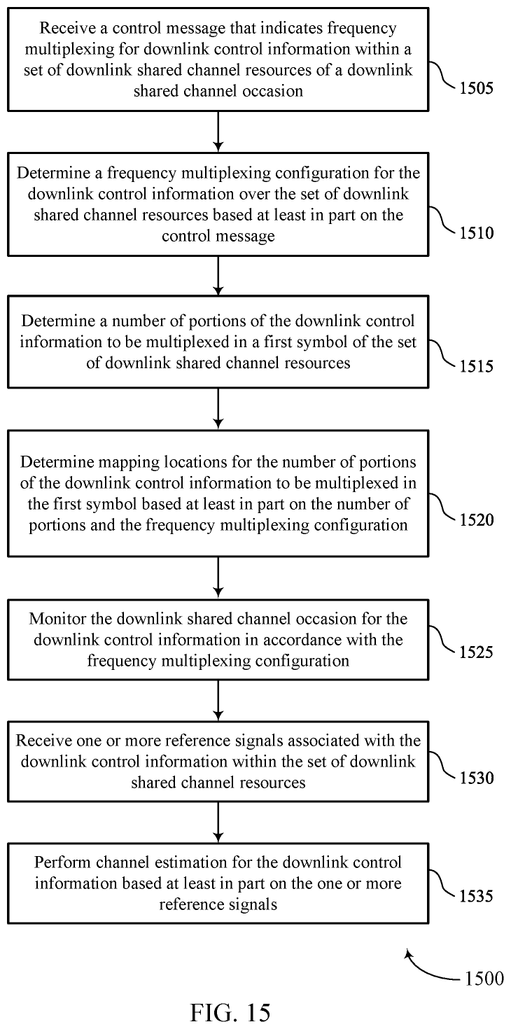

FIG. 15 shows a flowchart illustrating a method 1500 that supports frequency multiplexing for control information over shared channel resources in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving a control message that indicates frequency multiplexing for DCI within a set of downlink shared channel resources of a downlink shared channel occasion. The operations of 1505 may be performed in accordance with examples as disclosed herein. In some examples, aspects of the operations of 1505 may be performed by a control message receiver 825 as described with reference to FIG. 8. At 1510, the method may include determining a frequency multiplexing configuration for the DCI over the set of downlink shared channel resources based on the control message. The operations of 1510 may be performed in accordance with examples as disclosed herein. In some examples, aspects of the operations of 1510 may be performed by a frequency multiplexing configuration component 830 as described with reference to FIG. 8.

At 1515, the method may include determining a number of portions of the DCI to be multiplexed in a first symbol of the set of downlink shared channel resources based on a number of resource elements per symbol, a number of available resource element locations in the set of downlink shared channel resources, a content of the downlink control to be multiplexed in the first symbol, or any combination thereof, where monitoring the downlink shared channel occasion for the DCI is based on the number of portions of the DCI. The operations of 1515 may be performed in accordance with examples as disclosed herein. In some examples, aspects of the operations of 1515 may be performed by a frequency multiplexing configuration component 830 as described with reference to FIG. 8.

At 1520, the method may include determining mapping locations for the number of portions of the DCI to be multiplexed in the first symbol based on the number of portions and the frequency multiplexing configuration. The operations of 1520 may be performed in accordance with examples as disclosed herein. In some examples, aspects of the operations of 1520 may be performed by a frequency multiplexing mapping component 845 as described with reference to FIG. 8.

At 1525, the method may include monitoring the downlink shared channel occasion for the DCI in accordance with the frequency multiplexing configuration. The operations of 1525 may be performed in accordance with examples as disclosed herein. In some examples, aspects of the operations of 1525 may be performed by a monitoring component 835 as described with reference to FIG. 8.

At 1530, the method may include receiving one or more reference signals associated with the DCI within the set of downlink shared channel resources. The operations of 1530 may be performed in accordance with examples as disclosed herein. In some examples, aspects of the operations of 1530 may be performed by a monitoring component 835 as described with reference to FIG. 8.

At 1535, the method may include performing channel estimation for the DCI based on the one or more reference signals. The operations of 1535 may be performed in accordance with examples as disclosed herein. In some examples, aspects of the operations of 1535 may be performed by a channel estimation component 840 as described with reference to FIG. 8.

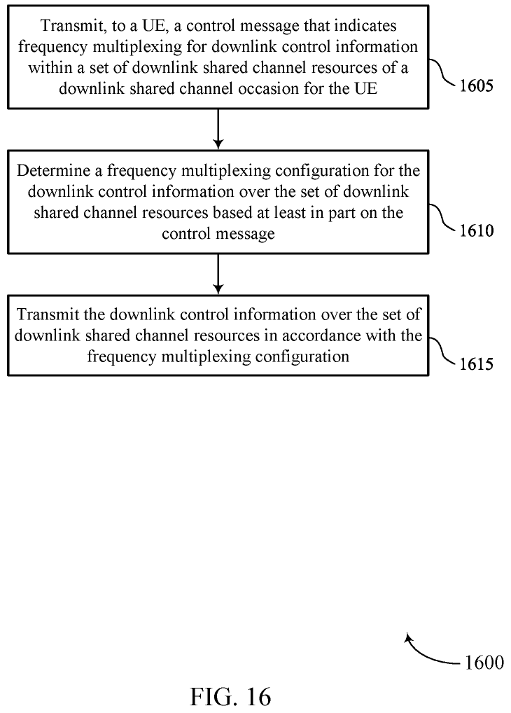

FIG. 16 shows a flowchart illustrating a method 1600 that supports frequency multiplexing for control information over shared channel resources in accordance with aspects of the present disclosure. The operations of the method 1600 may be implemented by a base station or its components as described herein. For example, the operations of the method 1600 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, a control message that indicates frequency multiplexing for DCI within a set of downlink shared channel resources of a downlink shared channel occasion for the UE. The operations of 1605 may be performed in accordance with examples as disclosed herein. In some examples, aspects of the operations of 1605 may be performed by a control message transmitter 1225 as described with reference to FIG. 12.

At 1610, the method may include determining a frequency multiplexing configuration for the DCI over the set of downlink shared channel resources based on the control message. The operations of 1610 may be performed in accordance with examples as disclosed herein. In some examples, aspects of the operations of 1610 may be performed by a frequency multiplexing configuration component 1230 as described with reference to FIG. 12. At 1615, the method may include transmitting the DCI over the set of downlink shared channel resources in accordance with the frequency multiplexing configuration. The operations of 1615 may be performed in accordance with examples as disclosed herein. In some examples, aspects of the operations of 1615 may be performed by a DCI transmitter 1235 as described with reference to FIG. 12.

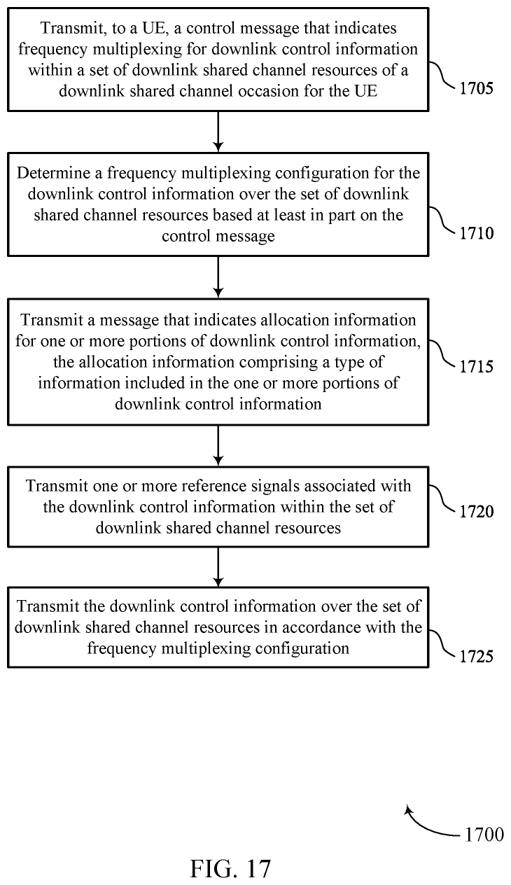

FIG. 17 shows a flowchart illustrating a method 1700 that supports frequency multiplexing for control information over shared channel resources in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, a control message that indicates frequency multiplexing for DCI within a set of downlink shared channel resources of a downlink shared channel occasion for the UE. The operations of 1705 may be performed in accordance with examples as disclosed herein. In some examples, aspects of the operations of 1705 may be performed by a control message transmitter 1225 as described with reference to FIG. 12.

At 1710, the method may include determining a frequency multiplexing configuration for the DCI over the set of downlink shared channel resources based on the control message. The operations of 1710 may be performed in accordance with examples as disclosed herein. In some examples, aspects of the operations of 1710 may be performed by a frequency multiplexing configuration component 1230 as described with reference to FIG. 12.

At 1715, the method may include transmitting a message that indicates allocation information for one or more portions of DCI, the allocation information including a type of information included in the one or more portions of DCI. The operations of 1715 may be performed in accordance with examples as disclosed herein. In some examples, aspects of the operations of 1715 may be performed by a control message transmitter 1225 as described with reference to FIG. 12. In some cases, the transmissions performed at 1705 and 1715 may be combined into a single message that indicates frequency multiplexing for DCI within a set of downlink shared channel resources of a downlink shared channel occasion for the UE and allocation information for one or more portions of DCI.

At 1720, the method may include transmitting one or more reference signals associated with the DCI within the set of downlink shared channel resources. The operations of 1720 may be performed in accordance with examples as disclosed herein. In some examples, aspects of the operations of 1720 may be performed by a DCI transmitter 1235 as described with reference to FIG. 12.

At 1725, the method may include transmitting the DCI over the set of downlink shared channel resources in accordance with the frequency multiplexing configuration. The operations of 1725 may be performed in accordance with examples as disclosed herein. In some examples, aspects of the operations of 1725 may be performed by a DCI transmitter 1235 as described with reference to FIG. 12.

The following provides an overview of aspects of the present disclosure:

Aspect 1: A method for wireless communications at a UE, comprising: receiving a control message that indicates frequency multiplexing for DCI within a set of downlink shared channel resources of a downlink shared channel occasion; determining a frequency multiplexing configuration for the DCI over the set of downlink shared channel resources based at least in part on the control message; and monitoring the downlink shared channel occasion for the DCI in accordance with the frequency multiplexing configuration.

Aspect 2: The method of aspect 1, further comprising: determining a frequency span for the DCI, the frequency span corresponding to a number of resource elements per symbol for multiplexing of the DCI within the set of downlink shared channel resources, wherein monitoring the downlink shared channel occasion for the DCI is based at least in part on the number of resource elements per symbol.

Aspect 3: The method of any of aspects 1 through 2, further comprising: determining a number of portions of the DCI to be multiplexed in a first symbol of the set of downlink shared channel resources based at least in part on a number of resource elements per symbol, a number of available resource element locations in the set of downlink shared channel resources, a content of the downlink control to be multiplexed in the first symbol, or any combination thereof, wherein monitoring the downlink shared channel occasion for the DCI is based at least in part on the number of portions of the DCI.

Aspect 4: The method of aspect 3, further comprising: determining mapping locations for the number of portions of the DCI to be multiplexed in the first symbol based at least in part on the number of portions and the frequency multiplexing configuration.

Aspect 5: The method of aspect 4, wherein determining the mapping locations comprises: determining a first mapping location for a first portion of the DCI based at least in part on a starting resource element index in the first symbol; and determining a second mapping location for a second portion of the DCI based at least in part on an offset and the first mapping location.

Aspect 6: The method of aspect 5, wherein the frequency multiplexing configuration comprises an indication of the first mapping location and the offset.

Aspect 7: The method of any of aspects 4 through 6, wherein the mapping locations correspond to resource elements indicated by the frequency multiplexing configuration.

Aspect 8: The method of any of aspects 4 through 7, wherein the mapping locations are uniformly spread within a bandwidth of the first symbol.

Aspect 9: The method of any of aspects 1 through 8, further comprising: receiving a message that indicates allocation information for one or more portions of DCI, the allocation information comprising a type of information included in the one or more portions of DCI.

Aspect 10: The method of any of aspects 1 through 9, further comprising: receiving one or more reference signals associated with the DCI within the set of downlink shared channel resources; and performing channel estimation for the DCI based at least in part on the one or more reference signals.

Aspect 11: The method of aspect 10, wherein at least one reference signal of the one or more reference signals is located in a first set of frequency resources of the set of downlink shared channel resources that is non-overlapping with a second set of resources of the set of downlink shared channel resources used for the DCI.

Aspect 12: The method of any of aspects 10 through 11, wherein at least one reference signal of the one or more reference signals is located in a first set of frequency resources of the set of downlink shared channel resources that is overlapping with a second set of resources of the set of downlink shared channel resources used for the DCI.

Aspect 13: The method of any of aspects 10 through 12, wherein the one or more reference signals are located in an initial set of time resources of the set of downlink shared channel resources.

Aspect 14: The method of any of aspects 10 through 13, further comprising: receiving an indication that the one or more reference signals are located in each symbol of the set of downlink shared channel resources.

Aspect 15: The method of any of aspects 1 through 14, further comprising: receiving, in a first symbol of the downlink shared channel resources, one or more reference signals for the set of downlink shared channel resources; and performing channel estimation for the first symbol based at least in part on the one or more reference signals.

Aspect 16: The method of aspect 15, further comprising: performing channel estimation for a second symbol of the set of downlink shared channel resources based at least in part on the one or more reference signals.

Aspect 17: The method of any of aspects 15 through 16, further comprising: receiving, in the first symbol of the downlink shared channel resources, one or more second reference signals dedicated for the DCI; and performing channel estimation for the DCI based at least in part on the one or more second reference signals.

Aspect 18: The method of any of aspects 1 through 17, further comprising: receiving one or more reference signals in one or more resource elements in at least one portion of the DCI, wherein the one or more reference signals are dedicated for the DCI, the set of downlink shared channel resources, or both; and performing channel estimation for the DCI based at least in part on the one or more reference signals.

Aspect 19: The method of any of aspects 1 through 18, wherein performing channel estimation comprises: interpolating between the at least one portion and at least one other portion in which the one or more reference signals are received to obtain a set of interpolated reference signals, wherein the channel estimation is performed based at least in part on the set of interpolated reference signals.

Aspect 20: The method of any of aspects 1 through 19, further comprising: receiving a first set of reference signals dedicated for the DCI on a first set of resource elements in one or more portions of the DCI; and performing channel estimation for the first symbol based at least in part on the first set of reference signals.

Aspect 21: The method of aspect 20, further comprising: receiving a second set of reference signals dedicated for the DCI on a second set of resource elements of the set of downlink shared channel resources, wherein the channel estimation is performed based at least in part on the first set of reference signals and the second set of reference signals.

Aspect 22: The method of aspect 21, wherein the first set of reference signals is received according to a first reference signal density and a first uniform spacing and the second set of reference signals is received according to a second reference signal density and a second uniform spacing.

Aspect 23: The method of any of aspects 21 through 22, wherein the first set of reference signals is received according to a first set of precoding parameters and the second set of reference signals is received according to a second set of precoding parameters.

Aspect 24: The method of any of aspects 1 through 23, further comprising: receiving a message that indicates frequency hopping is activated for the DCI; determining an offset for a frequency multiplexing pattern for the frequency multiplexing configuration; and monitoring for the DCI based at least in part on the offset.

Aspect 25: The method of any of aspects 1 through 24, further comprising: receiving each portion of the DCI according to a respective set of precoding parameters, wherein each of the respective sets of precoding parameters is different; and receiving respective sets of reference signals for each portion of the DCI based at least in part on the respective sets of precoding parameters.

Aspect 26: A method for wireless communications at a base station, comprising: transmitting, to a UE, a control message that indicates frequency multiplexing for DCI within a set of downlink shared channel resources of a downlink shared channel occasion for the UE; determining a frequency multiplexing configuration for the DCI over the set of downlink shared channel resources based at least in part on the control message; and transmitting the DCI over the set of downlink shared channel resources in accordance with the frequency multiplexing configuration.

Aspect 27: The method of aspect 26, further comprising: transmitting a message that indicates frequency hopping is activated for the frequency for the DCI; determining an offset for a frequency multiplexing pattern for the frequency multiplexing configuration; and transmitting the DCI based at least in part on the offset.

Aspect 28: The method of any of aspects 26 through 27, further comprising: transmitting a message that indicates allocation information for one or more portions of DCI, the allocation information comprising a type of information included in the one or more portions of DCI.

Aspect 29: The method of any of aspects 26 through 28, further comprising: transmitting one or more reference signals associated with the DCI within the set of downlink shared channel resources.

Aspect 30: The method of aspect 29, wherein at least one reference signal of the one or more reference signals is located in a first set of frequency resources of the set of downlink shared channel resources that is non-overlapping with a second set of resources of the set of downlink shared channel resources used for the DCI.

Aspect 31: The method of any of aspects 29 through 30, wherein at least one reference signal of the one or more reference signals is located in a first set of frequency resources of the set of downlink shared channel resources that is overlapping with a second set of resources of the set of downlink shared channel resources used for the DCI.

Aspect 32: The method of any of aspects 29 through 31, wherein the one or more reference signals are located in an initial set of time resources of the set of downlink shared channel resources.

Aspect 33: The method of any of aspects 29 through 32, further comprising: transmitting an indication that the one or more reference signals are located in each symbol of the set of downlink shared channel resources.

Aspect 34: The method of any of aspects 26 through 33, further comprising: transmitting, in a first symbol of the downlink shared channel resources, one or more reference signals for the set of downlink shared channel resources.

Aspect 35: The method of aspect 34, further comprising: transmitting, in the first symbol of the downlink shared channel resources, one or more second reference signals dedicated for the DCI.

Aspect 36: The method of any of aspects 26 through 35, further comprising: transmitting one or more reference signals in one or more resource elements in each portion of the DCI, wherein the one or more reference signals are dedicated for the DCI, the set of downlink shared channel resources, or both.

Aspect 37: The method of any of aspects 26 through 36, further comprising: transmitting a first set of reference signals dedicated for the DCI on a first set of resource elements in one or more portions of the DCI; and transmitting a second set of reference signals dedicated for the DCI on a second set of resource elements of the set of downlink shared channel resources.

Aspect 38: The method of aspect 37, wherein the first set of reference signals is transmitted according to a first reference signal density and a first uniform spacing and the second set of reference signals is transmitted according to a second reference signal density and a second uniform spacing.

Aspect 39: The method of any of aspects 37 through 38, wherein the first set of reference signals is transmitted according to a first set of precoding parameters and the second set of reference signals is transmitted according to a second set of precoding parameters.

Aspect 40: The method of any of aspects 26 through 39, further comprising: transmitting each portion of the DCI according to a respective set of precoding parameters, wherein each of the respective sets of precoding parameters is different; and transmitting respective sets of reference signals for each portion of the DCI based at least in part on the respective sets of precoding parameters.

Aspect 41: An apparatus for wireless communications at a UE, comprising a processor; memory coupled with the processor; and instructions stored in the memory and executable by the processor to cause the apparatus to perform a method of any of aspects 1 through 25.

Aspect 42: An apparatus for wireless communications at a UE, comprising at least one means for performing a method of any of aspects 1 through 25.

Aspect 43: A non-transitory computer-readable medium storing code for wireless communications at a UE, the code comprising instructions executable by a processor to perform a method of any of aspects 1 through 25.

Aspect 44: An apparatus for wireless communications at a base station, comprising a processor; memory coupled with the processor; and instructions stored in the memory and executable by the processor to cause the apparatus to perform a method of any of aspects 26 through 40.

Aspect 45: An apparatus for wireless communications at a base station, comprising at least one means for performing a method of any of aspects 26 through 40.

Aspect 46: A non-transitory computer-readable medium storing code for wireless communications at a base station, the code comprising instructions executable by a processor to perform a method of any of aspects 26 through 40.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a control message that indicates frequency multiplexing for downlink control information within a set of downlink shared channel resources of a downlink shared channel occasion;
determining a frequency multiplexing configuration for the downlink control information over the set of downlink shared channel resources based at least in part on the control message; and
monitoring the downlink shared channel occasion for the downlink control information in accordance with the frequency multiplexing configuration.

2. The method of claim 1, further comprising:
determining a frequency span for the downlink control information, the frequency span corresponding to a number of resource elements per symbol for multiplexing of the downlink control information within the set of downlink shared channel resources, wherein monitoring the downlink shared channel occasion for the downlink control information is based at least in part on the number of resource elements per symbol.

3. The method of claim 1, further comprising:
determining a number of portions of the downlink control information to be multiplexed in a first symbol of the set of downlink shared channel resources based at least in part on a number of resource elements per symbol, a number of available resource element locations in the set of downlink shared channel resources, a content of the downlink control information to be multiplexed in the first symbol, or any combination thereof, wherein monitoring the downlink shared channel occasion for the downlink control information is based at least in part on the number of portions of the downlink control information.

4. The method of claim 3, further comprising:
determining mapping locations for the number of portions of the downlink control information to be multiplexed in the first symbol based at least in part on the number of portions and the frequency multiplexing configuration.

5. The method of claim 4, wherein determining the mapping locations comprises:
determining a first mapping location for a first portion of the downlink control information based at least in part on a starting resource element index in the first symbol, one or more resource elements indicated by the frequency multiplexing configuration, or both; and
determining a second mapping location for a second portion of the downlink control information based at least in part on an offset, the first mapping location, the one or more resource elements, or some combination thereof.

6. The method of claim 5, wherein the frequency multiplexing configuration comprises an indication of the first mapping location and the offset.

7. The method of claim 1, further comprising:
receiving a message that indicates allocation information for one or more portions of downlink control information, the allocation information comprising a type of information included in the one or more portions of downlink control information.

8. The method of claim 1, further comprising:
receiving one or more reference signals associated with the downlink control information within the set of downlink shared channel resources; and
performing channel estimation for the downlink control information based at least in part on the one or more reference signals.

9. The method of claim 8, wherein at least one reference signal of the one or more reference signals is located in a first set of frequency resources of the set of downlink shared channel resources that is non-overlapping with a second set of resources of the set of downlink shared channel resources used for the downlink control information or overlapping with a second set of resources of the set of downlink shared channel resources used for the downlink control information.

10. The method of claim 8, further comprising:
receiving an indication that the one or more reference signals are located in each symbol of the set of downlink shared channel resources.

11. The method of claim 1, further comprising:
receiving, in a first symbol of the set of downlink shared channel resources, one or more reference signals, wherein the one or more reference signals are dedicated for the downlink control information, the set of downlink shared channel resources, or both; and
performing channel estimation for the first symbol based at least in part on the one or more reference signals.

12. The method of claim 11, further comprising:
performing channel estimation for a second symbol of the set of downlink shared channel resources based at least in part on the one or more reference signals.

13. The method of claim 1, further comprising:
receiving one or more reference signals in one or more resource elements in at least one portion of the downlink control information, wherein the one or more reference signals are dedicated for the downlink control information, the set of downlink shared channel resources, or both; and
performing channel estimation for the downlink control information based at least in part on the one or more reference signals.

14. The method of claim 1, wherein performing channel estimation comprises:
interpolating between the at least one portion and at least one other portion in which the one or more reference signals are received to obtain a set of interpolated reference signals, wherein the channel estimation is performed based at least in part on the set of interpolated reference signals.

15. The method of claim 1, further comprising:
receiving a first set of reference signals dedicated for the downlink control information on a first set of resource elements in one or more portions of the downlink control information; and
performing channel estimation for the downlink control information based at least in part on the first set of reference signals.

16. The method of claim 15, further comprising:
receiving a second set of reference signals dedicated for the downlink control information on a second set of resource elements of the set of downlink shared channel resources, wherein the channel estimation is performed based at least in part on the first set of reference signals and the second set of reference signals.

17. The method of claim 16, wherein the first set of reference signals is received according to a first reference signal density, a first uniform spacing, and a first set of precoding parameters, and the second set of reference signals is received according to a second reference signal density, a second uniform spacing, and a second set of precoding parameters.

18. The method of claim 1, further comprising:
receiving a message that indicates frequency hopping is activated for the downlink control information;
determining an offset for a frequency multiplexing pattern for the frequency multiplexing configuration; and
monitoring for the downlink control information based at least in part on the offset.

19. The method of claim 1, further comprising:
receiving each portion of the downlink control information according to a respective set of precoding parameters, wherein each of the respective sets of precoding parameters is different; and
receiving respective sets of reference signals for each portion of the downlink control information based at least in part on the respective sets of precoding parameters.

20. A method for wireless communications at a base station, comprising:
transmitting, to a user equipment (UE), a control message that indicates frequency multiplexing for downlink control information within a set of downlink shared channel resources of a downlink shared channel occasion for the UE;
determining a frequency multiplexing configuration for the downlink control information over the set of downlink shared channel resources based at least in part on the control message; and
transmitting the downlink control information over the set of downlink shared channel resources in accordance with the frequency multiplexing configuration.

21. The method of claim 20, further comprising:
transmitting a message that indicates frequency hopping is activated for the downlink control information;
determining an offset for a frequency multiplexing pattern for the frequency multiplexing configuration; and
transmitting the downlink control information based at least in part on the offset.

22. The method of claim 20, further comprising:
transmitting a message that indicates allocation information for one or more portions of downlink control information, the allocation information comprising a type of information included in the one or more portions of downlink control information.

23. The method of claim 20, further comprising:
transmitting one or more reference signals associated with the downlink control information within the set of downlink shared channel resources.

24. The method of claim 23, wherein at least one reference signal of the one or more reference signals is located in a first set of frequency resources of the set of downlink shared channel resources that is non-overlapping with a second set of resources of the set of downlink shared channel resources or overlapping with a second set of resources of the set of downlink shared channel resources.

25. The method of claim 23, further comprising:
transmitting an indication that the one or more reference signals are located in an initial set of time resources of the set of downlink shared channel resources, each symbol of the set of downlink shared channel resources, or both.

26. The method of claim 20, further comprising:
transmitting, in a first symbol of the set of downlink shared channel resources, one or more reference signals, wherein the one or more reference signals are dedicated for the downlink control information, the set of downlink shared channel resources, or both.

27. The method of claim 20, further comprising:
transmitting a first set of reference signals on a first set of resource elements in one or more portions of the downlink control information wherein the first set of reference signals is dedicated for the downlink control information, the set of downlink shared channel resources, or both; and
transmitting a second set of reference signals on a second set of resource elements of the set of downlink shared channel resources, wherein the second set of reference signals is dedicated for the downlink control information, the set of downlink shared channel resources, or both.

28. The method of claim 27, wherein the first set of reference signals is transmitted according to a first reference signal density, a first uniform spacing, and a first set of precoding parameters, and the second set of reference signals is transmitted according to a second reference signal density, a second uniform spacing, and a second set of precoding parameters.

29. An apparatus for wireless communications at a user equipment (UE), comprising:
a processor;
memory coupled with the processor; and
instructions stored in the memory and executable by the processor to cause the apparatus to:
receive a control message that indicates frequency multiplexing for downlink control information within a set of downlink shared channel resources of a downlink shared channel occasion;
determine a frequency multiplexing configuration for the downlink control information over the set of downlink shared channel resources based at least in part on the control message; and
monitor the downlink shared channel occasion for the downlink control information in accordance with the frequency multiplexing configuration.

30. An apparatus for wireless communications at a base station, comprising:
a processor;
memory coupled with the processor; and
instructions stored in the memory and executable by the processor to cause the apparatus to:
transmit, to a user equipment (UE), a control message that indicates frequency multiplexing for downlink control information within a set of downlink shared channel resources of a downlink shared channel occasion for the UE;
determine a frequency multiplexing configuration for the downlink control information over the set of downlink shared channel resources based at least in part on the control message; and
transmit the downlink control information over the set of downlink shared channel resources in accordance with the frequency multiplexing configuration.
